(19) United States
(12) Patent Application Publication
(10) Pub. No.: US 2019/0354647 A1
(43) Pub. Date: Nov. 21, 2019

(54) WIND NOISE ANALYZING APPARATUS AND METHOD FOR ANALYZING WIND NOISE

(71) Applicant: TOYOTA JIDOSHA KABUSHIKI KAISHA, Toyota-shi (JP)

(72) Inventor: Phan Vinh LONG, Aichi-gun (JP)

(73) Assignee: TOYOTA JIDOSHA KABUSHIKI KAISHA, Toyota-shi (JP)

(21) Appl. No.: 16/414,351

(22) Filed: May 16, 2019

(30) Foreign Application Priority Data
May 17, 2018 (JP) 2018-095628

(51) Int. Cl. G06F 17/50

(52) U.S. Cl. CPC G06F 17/5009; G06F 2217/16; G06F 17/5095

(57) ABSTRACT

A wind noise analyzing apparatus comprises non-stationary CFD calculating measure for running a non-stationary CFD simulation to make a structure model run to calculate an average fluid velocity and an average vorticity in a predetermined period of time of a flow field within a predetermined region out of a flow field around the model for every spatial node within the region as well as to calculate a value based on an amplitude of a disturbed fluid velocity within the region for every spatial node in an angular frequency band-of-interest and acoustic pressure density source calculating measure for calculating, based on these calculated values, an acoustic pressure density source which is an index showing a degree of contribution of a flow field at a spatial node within the region to a surface acoustic pressure fluctuation in an angular frequency band-of-interest at a target point-to-be-analyzed.

### TECHNICAL FIELD

The present invention relates to a wind noise analyzing apparatus and a method for analyzing the wind noise to analyze wind noise generated on and around a moving structure. Especially, the present invention relates to the wind noise analyzing apparatus and the method for analyzing the wind noise to analyze wind noise generated due to fluctuation in surface acoustic pressure in a high-frequency region at a part of the structure, the part being made of glass.

### BACKGROUND ART

A technique to reduce wind noise has been studied and developed, the wind noise being generated when a structure such as a vehicle is moving. For example, Japanese Patent Application Laid-Open (kokai) No. 2017-062727 discloses a technique to perform a simulation of running a vehicle model to obtain an “amplitude of pressure fluctuation” and an “average fluid velocity” at an arbitrary position of a surface of the vehicle model and thereby to calculate, based on these values, an intensity of a sound source of wind noise at the arbitrary position for every frequency band desired.

It should be noted that wind noise is a noise generated due to a fluid flow around a structure, and in the present specification, the wind noise especially means a noise reaching inside of the structure.

### SUMMARY OF THE INVENTION

Among the aforementioned amplitude of the pressure fluctuation and average fluid velocity on the surface of the structure, the intensity of the wind noise has a strong correlation especially with the amplitude of the pressure fluctuation. Here, a pressure generated on a surface of a moving structure is composed of a convective pressure and an acoustic pressure. The convective pressure is transmitted at a fluid current velocity and is not transmitted very far, whereas the acoustic pressure has relatively long wavelength and small amplitude. Specifically, an amplitude of fluctuation in the acoustic pressure is approximately one hundredth to one thousandth of an amplitude of fluctuation in the convective pressure. Therefore, in a normal case, most of the pressure on the surface of the moving structure is originated from the convective pressure, and the intensity of the wind noise has a strong correlation with the amplitude of the fluctuation in the convective pressure.

However, a wavelength of the acoustic pressure becomes substantially equal to a wavelength of vibration mode of glass in the high-frequency region (a frequency band of 2 kHz, for example). Thus, in a case where a housing (chassis, frame) of the structure includes not only a part made of metal and/or resin but also a part made of glass, the fluctuation in the acoustic pressure on the surface of this glass-made part in the high-frequency region causes the glass-made part to resonate and thereby the amplitude of the fluctuation in the acoustic pressure increases, resulting in the intensity of the wind noise being raised. In this case, the intensity of this wind noise has a strong correlation with the amplitude of the fluctuation in the acoustic pressure, not with the amplitude of the fluctuation in the convective pressure. Hereinafter, an amplitude of the pressure fluctuation, an amplitude of the fluctuation in the acoustic pressure, and an amplitude of the fluctuation in the convective pressure, each of which being an amplitude on a surface of a structure, will be also referred to as a “surface pressure fluctuation”, a “surface acoustic pressure fluctuation”, and a “surface convective pressure fluctuation”, respectively.

The surface pressure fluctuation (that is, a sum of the surface acoustic pressure fluctuation and the surface convective pressure fluctuation) changes due to flow field (typically, a fluid velocity and a vorticity) around a structure. Therefore, in order to reduce the wind noise generated due to the surface acoustic pressure fluctuation of the glass-made part of the structure in the high-frequency region, it is required to identify a position out of the glass-made part, the position having a relatively large surface acoustic pressure fluctuation, to identify which part (position) of flow field out of the flow field around the structure has a strong influence on the surface acoustic pressure fluctuation at the identified position, and thereafter to change the flow field of the identified part (that is, change a component shape of the structure) so that the surface acoustic pressure fluctuation at the above identified position may be reduced. However, there is no integrated method in a “method for identifying a part of the flow field, the part having a large contribution to the surface acoustic pressure fluctuation”. In reality, engineers identify the part of the flow field based on their know-how and knowledge. This causes a problem that investigation results vary depending on engineers and frequent trial and errors are required.

The present invention is made to resolve the problem above. That is, one of objects of the present invention is to provide a technique capable of properly identifying a position of flow field around a structure, the position having a large contribution to a surface acoustic pressure fluctuation in a high-frequency region at a glass-made part of the structure such as a vehicle.

A wind noise analyzing apparatus of the present invention is configured to analyze wind noise generated on a surface of a glass-made part which is a part made of glass of a moving structure.

The wind noise analyzing apparatus comprises;

non-stationary CFD calculation means (steps 802, 804, 806) for running a non-stationary CFD simulation to make a structure model (20) move to calculate an average fluid velocity (U-) and an average vorticity (Ω-) in a predetermined period of time of a flow field within a predetermined region (21) out of a flow field around the structure model (20) for every spatial node (z) which is a node within the predetermined region (21) as well as to calculate a value based on an amplitude of a disturbed fluid velocity (u˜_{θ}) within the predetermined region (21) for every spatial node (z) in an angular frequency band-of-interest ([θₗ, θₕ]) which is an angular frequency band, wind noise is to be analyzed therein; and

acoustic pressure density source calculating means (step 808) for calculating, based on the average fluid velocity (U-), the average vorticity (Ω-), and the amplitude of the disturbed fluid velocity (u˜_{θ}), each of which being calculated by the non-stationary CFD calculation means (steps 802, 804, 806), an acoustic pressure density source (APDS) which is an index showing a degree of contribution of a flow field at a spatial node (z) within the predetermined region (21) to a surface acoustic pressure fluctuation (pa_{θ}) which is an amplitude of a fluctuation in an acoustic pressure in an angular frequency band-of-interest ([θₗ, θₕ]) at a target point-to-be-analyzed (x) which is a point at which wind noise is to be analyzed, the wind noise being on a surface of a glass-made part (22) of the structure model (20).

The wind noise analyzing apparatus of the present invention (hereinafter, also referred to as a “present invention apparatus”) calculates the acoustic pressure density source in the angular frequency band-of-interest based on the physical quantities (the average fluid velocity, the average vorticity, and the disturbed fluid velocity) calculated by the non-stationary CFD simulation to make the structure model move. This acoustic pressure density source is an index showing a degree of contribution of the “flow field at a spatial node within the predetermined region” to the “surface acoustic pressure fluctuation in the angular frequency band-of-interest at the target point-to-be-analyzed on the surface of the glass-made part of the structure model”. Here, the predetermined region is a part of the flow field around the structure model and is defined as a region having a possibility of affecting the surface acoustic pressure fluctuation at the target point-to-be-analyzed. Therefore, using the acoustic pressure density source as the index enables to calculate the degree of contribution of the flow field to the surface acoustic pressure fluctuation in the angular frequency band-of-interest for every spatial node. Hence, according to the present invention apparatus, it becomes possible to properly identify what position of the flow field within the predetermined region has a large contribution to the surface acoustic pressure fluctuation in a high-frequency region on the glass-made part of the structure model at the target point-to-be-analyzed. It should be noted that the surface acoustic pressure fluctuation has a strong correlation with wind noise, where wind noise becomes louder as the surface acoustic pressure fluctuation becomes larger. Hence, analyzing the surface acoustic pressure fluctuation is synonymous with analyzing wind noise in a broad sense.

In another aspect of the present invention apparatus,

a value obtained by a space integration of the acoustic pressure density source (APDS) in an angular frequency band-of-interest ([θₗ, θₕ]) for the target point-to-be-analyzed (x) on the surface of the glass-made part (22) of the structure model (20) over the predetermined region (21) is an approximate value of a value obtained by integrating a product of a function of the surface acoustic pressure fluctuation (pa_{θ}) at the target point-to-be-analyzed (x) and a complex conjugate function thereof (pa_{θ}*) over the angular frequency band-of-interest ([θₗ, θₕ]).

According to this configuration, a behavior of the acoustic pressure density source accurately matches with a behavior of the surface acoustic pressure fluctuation on (at) the glass-made part of the structure model. That is, the acoustic pressure density source has a high reliability as the index showing the degree of contribution of the flow field to the surface acoustic pressure fluctuation. Therefore, it becomes possible to identify a position of the flow field around the structure with high accuracy, the position having a large contribution to the surface acoustic pressure fluctuation in the high-frequency region at the glass-made part of the structure.

Another aspect of the present invention apparatus further comprises a cause parameter identifying means for identifying a cause parameter which is a parameter out of a plurality of parameters constituting the acoustic pressure density source (APDS), the parameter having a relatively large contribution to the acoustic pressure density source (APDS).

According to this configuration, a parameter causing a large APDS value can be easily grasped, enabling to examine and change a shape of the structure model in a more efficient way.

In another aspect of the present invention apparatus, the plurality of parameters are the average fluid velocity (U-), the average vorticity (Ω-), and the disturbed fluid velocity (u˜_{θ}).

Another aspect of the present invention apparatus further comprises image processing means (step 820) for extracting spatial nodes (z) out of a plurality of spatial nodes (z) at each of which the acoustic pressure density source (APDS) has been calculated, the extracted spatial nodes (z) corresponding to an acoustic pressure density source (APDS) having a value input from outside, performing an image processing of the extracted spatial nodes (z) to create an equivalent surface (28, 30, 32), and visualizing the equivalent surface (28, 30, 32).

According to this configuration, the equivalent surface of APDS is displayed, which enables an operator to visually recognize the equivalent surface having a desired APDS value by the operator properly setting an input value. As a result, the operator can select the spatial node corresponding to the desired APDS value in an efficient way and identify the position of the flow field around the structure, the position having a large contribution to the surface acoustic pressure fluctuation in the high-frequency region at the glass-made part of the structure in an efficient way.

Another aspect of the present invention apparatus further comprises spatial node extracting means for extracting a spatial node (z) corresponding to a maximum value among a plurality of acoustic pressure density sources (APDS) calculated by the acoustic pressure density source calculating means (step 808).

According to this configuration, it becomes unnecessary for the operator to select a spatial node corresponding to the maximum APDS value, and thus it becomes possible to identify the position of the flow field around the structure, the position having a large contribution to the surface acoustic pressure fluctuation in the high-frequency region at the glass-made part of the structure in a more efficient way. It should be noted that the “maximum value of the acoustic pressure density source” means a “value with a substantially maximum acoustic pressure density source” in a broad sense.

In another aspect of the present invention apparatus, a calculation formula of the acoustic pressure density source is defined by a following formula;

$$APDS ( x , z ) = \frac{{ρ}^{2} {k}_{0}^{2} \overline{‖ {\tilde{u}}_{θ} ‖}}{12 {π}^{2} {r}^{4}} \{ {( k \frac{{θ}_{m}}{c} )}^{2} \times {\vert \overline{U} \vec{r} \vert}^{2} + {\vert \overline{Ω} \vec{r} \vert}^{2} \} {V}_{z , cr} \qquad$$

where APDS represents an acoustic pressure density source, x represents a target point-to-be-analyzed, z represents a spatial node, p represents a density of a flow field, k₀ represents an acoustic wave number, a norm of u˜_{θ} with a bar thereon represents a value obtained by integrating a product of a function of an amplitude of a disturbed fluid velocity and a complex conjugate function thereof over an angular frequency band-of-interest, r represents a distance between x and z, k represents a constant, θₘ represents a center angular frequency in a angular frequency band-of-interest, c represents an acoustic velocity of a flow field, U- represents an average fluid velocity, a vector r represents an expression of a vector z−a vector x, Ω- represents an average vorticity, and V_{z,cr} represents a correlation volume including z.

In addition, the present specification discloses a novel wind noise analyzing method for analyzing wind noise generated on a surface of a glass-made part which is a part made of glass of a moving structure.

The wind noise analyzing method comprises;

non-stationary CFD calculation process (steps 802, 804, 806) for running a non-stationary CFD simulation to make a structure model (20) move to calculate an average fluid velocity (U-) and an average vorticity (Ω-) in a predetermined period of time of a flow field within a predetermined region (21) out of a flow field around the structure model (20) for every spatial node (z) which is a node within the predetermined region (21) as well as to calculate a value based on an amplitude of a disturbed fluid velocity (u˜_{θ}) within the predetermined region (21) for the every spatial node (z) in an angular frequency band-of-interest ([θₗ, θₕ]) which is an angular frequency band, wind noise is to be analyzed therein; and

acoustic pressure density source calculating process (step 808) for calculating, based on the average fluid velocity (U-), the average vorticity (Ω-), and the amplitude of the disturbed fluid velocity (u˜_{θ}), each of which being calculated by the non-stationary CFD calculation process (steps 802, 804, 806), an acoustic pressure density source (APDS) which is an index showing a degree of contribution of a flow field at a spatial node (z) within the predetermined region (21) to a surface acoustic pressure fluctuation (pa_{θ}) which is an amplitude of a fluctuation in an acoustic pressure in an angular frequency band-of-interest ([θₗ, θₕ]) at a target point-to-be-analyzed (x) which is a point at which wind noise is to be analyzed, the wind noise being on a surface of a glass-made part (22) of the structure model (20).

According to this wind noise analyzing method, it becomes possible to properly identify what position of the flow field within the predetermined region has a large contribution to the surface acoustic pressure fluctuation in a high-frequency region on the glass-made part of the structure model at the target point-to-be-analyzed.

In the above description, references used in the following descriptions regarding embodiments are added with parentheses to the elements of the present invention, in order to assist in understanding the present invention. However, those references should not be used to limit the scope of the invention.

### BRIEF DESCRIPTION OF THE DRAWINGS

FIG. 1 is a block diagram showing a calculation apparatus included in a wind noise analyzing apparatus (hereinafter, referred to as a “present embodiment apparatus” or an “embodiment apparatus”) according to an embodiment of the present invention.

FIG. 2 is a schematic diagram of a vehicle model and a flow domain, each of which is subject to a non-stationary CFD simulation.

FIG. 3A is a distribution diagram of a surface acoustic pressure fluctuation on a surface-to-be-analyzed (a right-sided front side glass) of the vehicle model.

FIG. 3B is a diagram showing a position of an observation point at which the surface acoustic pressure fluctuation (wind noise) is to be analyzed.

FIG. 4A is a diagram used to describe a method for selecting an evaluation point-of-interest and shows an equivalent surface where a reference value of APDS is a criteria value.

FIG. 4B is a diagram showing an equivalent surface where a reference value of APDS is 16 times as large as the criteria value.

FIG. 4C is a diagram showing an equivalent surface where a reference value of APDS is 256 times as large as the criteria value.

FIG. 5A is a diagram showing a position of a plane (a cross section-passing-the-evaluation-point-of-interest) with which a distribution diagram of a cause parameter (an average fluid velocity) is created.

FIG. 5B is a distribution diagram of the average velocity around a right-sided side mirror on the cross section-passing-the-evaluation-point-of-interest.

FIG. 6 is a diagram used to describe a method for deriving an APDS calculation formula and a schematic diagram of a rigid model and a flow domain.

FIG. 7 is a schematic diagram of the rigid model and the flow domain.

FIG. 8 is a flowchart showing a procedure of a wind noise analyzing method.

FIG. 9 is a flowchart showing a procedure of a wind noise analyzing method.

FIG. 10A is a diagram used to describe an improved effect of the surface acoustic pressure fluctuation (wind noise) in a case when a shape of the vehicle model is changed and shows a part of a front view of the vehicle model before the shape is changed.

FIG. 10B is a plan view of the right-sided side mirror before the shape is changed.

FIG. 11A is a part of a front view of the vehicle model after the shape is changed.

FIG. 11B is a plan view of the right-sided side mirror after the shape is changed.

FIG. 12A is a distribution diagram of the average fluid velocity around the right-sided side mirror on the cross section-passing-the-evaluation-point-of-interest before the shape is changed.

FIG. 12B is a distribution diagram of the average fluid velocity around the right-sided side mirror on the cross section-passing-the-evaluation-point-of-interest after the shape is changed.

FIG. 13 is a distribution diagram of the surface acoustic pressure fluctuation at the right-sided front side glass of the vehicle model after the shape is changed.

FIG. 14A is a schematic diagram of the vehicle model used to describe reliability and versatility of APDS as an index.

FIG. 14B is a schematic diagram of a fore step model.

FIG. 15A is a distribution diagram of a predicted surface acoustic pressure fluctuation calculated using APDS at the right-sided front side glass of the vehicle model.

FIG. 15B is a distribution diagram of the surface acoustic pressure fluctuation calculated by a non-stationary CFD simulation of a software at the right-sided front side glass of the vehicle model.

FIG. 16A is a distribution diagram of the predicted surface acoustic pressure fluctuation calculated using APDS at an upper surface of a step of a fore step model.

FIG. 16B is a distribution diagram of the predicted surface acoustic pressure fluctuation calculated by the non-stationary CFD simulation of the software at the upper surface of the step of the fore step model.

FIG. 17 is a graph showing an error of the predicted surface acoustic pressure fluctuation with respect to the surface acoustic pressure fluctuation for the vehicle model and the fore step model.

### DESCRIPTION OF THE EMBODIMENT

### Summary of a Present Embodiment Apparatus

First, a summary of a wind noise analyzing apparatus (hereinafter, also referred to as a “present embodiment apparatus”) according to an embodiment will be described. While the present embodiment apparatus analyzes wind noise generated when various structures are moving, in the present embodiment, a description will be made by taking a vehicle among a structure as an example. Wind noise generated when a vehicle is traveling (in other words, a noise audible to a passenger in the vehicle) is complex noises due to amplitudes of pressure fluctuations in various frequency bands at a plurality of positions on a surface of the vehicle (that is, a surface pressure fluctuation and in other words, a sum of a surface acoustic pressure fluctuation and a surface convective pressure fluctuation). Among these complex wind noises, wind noise in a high-frequency region has a strong correlation with a surface acoustic pressure fluctuation in the high-frequency region at a glass-made part of the vehicle (For example, a front side glass, a rear side glass, a front glass, and a rear glass. Hereinafter, this part will be also referred to as a “glass part”.)

The surface acoustic pressure fluctuation changes due to flow field (fluid velocity and vorticity) around the vehicle. In the present embodiment apparatus, a calculation formula of an index has been stored in advance, the index showing a quantitative relationship between the flow field around the vehicle and the surface acoustic pressure fluctuation (in other words, the index showing how much “(a state of) the flow field at an arbitrary position around the vehicle” contributes to the “surface acoustic pressure fluctuation at an arbitrary position of the glass part of the vehicle”). A degree of contribution becomes higher as an index value becomes large. This index includes following physical quantities as parameters, the physical quantities being an average fluid velocity, a disturbed fluid velocity, an average vorticity, and the like of the flow field at the arbitrary position around the vehicle. In addition, the surface acoustic pressure fluctuation at the arbitrary position of the glass part of the vehicle can be calculated (predicted) based on a value obtained by a space integration of this index over the flow field within a predetermined region. Therefore, the present embodiment apparatus calculates, by non-stationary CFD (computational fluid dynamics) calculation, the average fluid velocity, the disturbed fluid velocity, and the average vorticity of the flow field within the predetermined region out of a region around the vehicle model for every position within the predetermined region to calculate, based on these values, the above index for every position within the predetermined region. Thereafter, the present embodiment apparatus calculates (predicts), based on this index, the surface acoustic pressure fluctuation of the moving vehicle model for every position on the surface of the glass part of the vehicle model and for every frequency band. An operator selects, based on the calculation result, a position with a relatively large surface acoustic pressure fluctuation (in other words, a position causing large wind noise). It should be noted that the vehicle model corresponds one example of a “structure model”.

The operator selects, based on the calculation result, a position of the flow field with a relatively large index value, the index being one of a plurality of indexes which are related to the above selected position and have been calculated for every position within the predetermined region. This selected position of the flow field is a position with a relatively high contribution to the surface acoustic pressure fluctuation at the above selected position. The operator thereafter identifies a physical quantity causing the large index value among each physical quantity (that is, the average fluid velocity, the disturbed fluid velocity, and the average vorticity) consisting the index at the selected position of the flow field. The operator then examines and changes a shape of the vehicle model based on a value of the identified physical quantity so that the index value at the above selected position of the flow field may be reduced. According to this configuration, by changing a shape of the vehicle model so that the index value may be reduced, it becomes possible to reduce a “contribution of the flow field at the position having this index value to the surface acoustic pressure fluctuation at the above selected position”. Hence, the surface acoustic pressure fluctuation at the selected position can be reduced and as a result, it can be realized to reduce wind noise.

### Specific Configuration of the Present Embodiment Apparatus

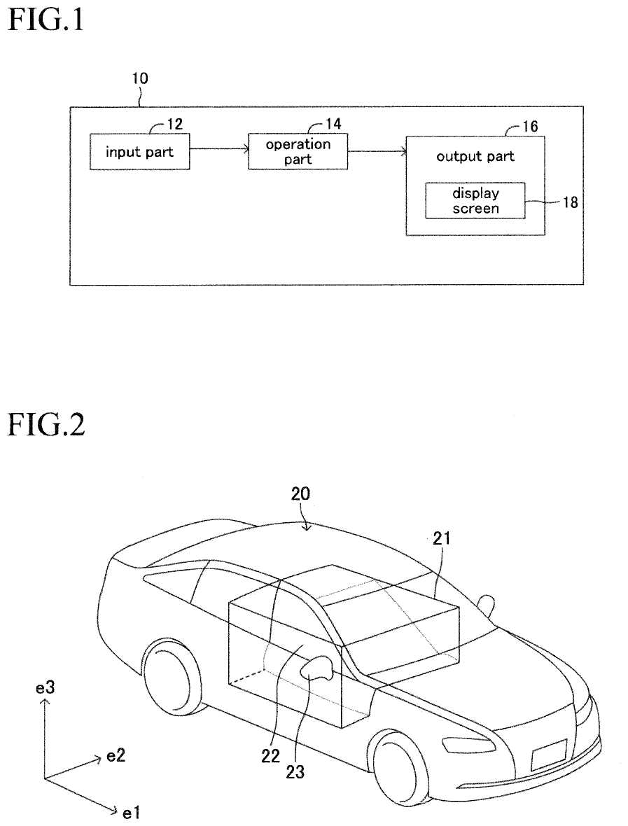

Hereinafter, a specific description on the present embodiment apparatus will be made, referring to figures. As shown in FIG. 1, the present embodiment apparatus comprises a calculating apparatus 10. The calculating apparatus 10 comprises an input part 12, an operation part 14, and an output part 16. The output part 16 includes a display screen 18 at a position visible to the operator. The input part 12 inputs data of a three-dimensional vehicle model subject to analysis of wind noise, data of a flow domain showing an analysis scope, data necessary for the non-stationary CFD simulation, and so on. Besides, the input part 12 inputs data of coordinates selected by the operator in the midst of processing, a reference value of index, a cause parameter, and so on (described later).

FIG. 2A is a schematic diagram showing a three-dimensional vehicle model 20 (hereinafter, simply referred to as a “vehicle model 20”) and a flow domain 21. As shown in FIG. 2A, a spatial coordinate system of the vehicle model 20 consists of an e1 axis, an e2 axis, and an e3 axis. This coordinate system is arranged so that a front direction in a front-rear direction of the vehicle model 20 coincides with +e1 direction and a left direction in a left-right direction of the vehicle model 20 coincides with +e2 direction. In addition, an origin is placed at a position apart from a reference point of the vehicle model 20 (a center of gravity, for example) in a predetermined direction and by a predetermined distance (including a zero value).

The flow domain 21 is a region showing a scope out of a space around the vehicle model 20. The non-stationary CFD calculation is performed in this scope. In the present embodiment, an analysis of wind noise is performed, the wind noise being generated due to a surface acoustic pressure fluctuation at a right-sided front side glass 22 of the traveling vehicle model 20. Thus, the flow domain 21 is arranged as a “region including a part of the flow field around the vehicle model 20, the part having a possibility of affecting the surface acoustic pressure fluctuation at the right-sided front side glass 22”. Specifically, the flow domain 21 has a shape where a part overlapping with the vehicle model 20 is hollowed out of (removed from) a space having a substantially rectangular parallelepiped shape including the right-sided front side glass 22, a right-sided side mirror 23, a right-sided front pillar, a right half of the front glass, and the like. The flow domain 21 can be freely arranged, depending on which part out of the vehicle model 20 is to be analyzed. It should be noted that the flow domain 21 corresponds to one example of the “predetermined region”.

These data input at the input part 12 are stored in RAM (described later) of the operation part 14. Hereinafter, the non-stationary CFD calculation will be also simply referred to as a “CFD calculation”.

Referring back to FIG. 1, the operation part 14 includes a microcomputer consisting of CPU, ROM, RAM, and the like as a main component part. The operation part 14 includes interfaces of every kind. The operation part 14 is connected to the input part 12 and the output part 16 via the interfaces in such a manner that a signal can be input and output with the parts 12 and 16.

The operation part 14 carries out the non-stationary CFD simulation to make the vehicle model 20 run by using the above mentioned data stored in the RAM. The CFD calculation process includes a calculation process of time history data, an averaging process, and a fast Fourier transform process. The calculation process is performed within a scope divided by the flow domain 21. A specific description will be made below.

### 1. Calculation Process of Time History Data

The operation part 14 calculates, for each spatial node z within the flow domain 21, time history data u (z, t) of the fluid velocity and time history data w (z, t) of the vorticity of the flow field over a predetermined period of time, respectively. Hereinafter, the spatial node z will be simply referred to as a “node z”. It should be noted that positions of nodes z within the flow domain 21 are arranged in advance in such a manner that the nodes z do not exist on a surface of the vehicle model 20 (that is, in such a manner that the nodes z are apart from the surface of the vehicle model 20). The operation part 14 stores the time history data u (z, t) of the fluid velocity and the time history data w (z, t) of the vorticity in the RAM thereof, associating these data with a coordinate of each node z and time t.

### 2. Averaging Process

The operation part 14 averages the time history data u (z, t) of the fluid velocity and the time history data w (z, t) of the vorticity stored in the RAM, respectively to calculate an average fluid velocity U-(z) and an average vorticity Ω-(z) for each node z within the flow domain 21. It should be noted that “-” of both U-(z) and Ω-(z) is a notation indicating an average and is used in place of a bar put on top of each of the letters U and Ω in formulae described later. The operation part 14 stores the average fluid velocity U-(z) and the average vorticity Ω-(z) in the RAM thereof, associating these values with a coordinate of each node z. The average fluid velocity U-(z) and the average vorticity Ω-(z) are used when calculating the index (described later).

### 3. Fast Fourier Transform Process

The operation part 14 performs fast Fourier transform on the time history data u (z, t) of the fluid velocity stored in the RAM to calculate, for each node z within the flow domain 21, an autocorrelation function (described later) of a disturbed fluid velocity (strictly, an amplitude of a disturbed fluid velocity) u˜_{θ}(z) (θ: angular frequency, θ=2πf) for every frequency (angular frequency). It should be noted that “-” of u˜_{θ}(z) is a notation indicating a disturbed component obtained by averaging the fluid velocity u and is used in place of tilde put on top of the letter u in formulae described later. The autocorrelation function of the amplitude u˜_{θ}(z) of the disturbed fluid velocity corresponds to one example of a “value based on an amplitude of a disturbed fluid velocity”.

The autocorrelation function is calculated in frequency bands where wind noise is analyzed (Hereinafter, each of these frequency bands will be also referred to as a “frequency band-of-interest”.). The frequency band-of-interest can be selected by the operator. For example, frequency bands having a center frequency fₘ of 500 Hz, 1 kHz, 2 kHz, or 4 kHz may be selected. The present embodiment apparatus is configured to analyze the wind noise due to the surface acoustic pressure fluctuation in a high-frequency region, and therefore a frequency band with more than or equal to 2 kHz may be typically selected. For instance, in a case where 2 kHz (a lower limit frequency fₗ=1420 Hz and an upper limit frequency fₕ=2840 Hz) is selected as the frequency band-of-interest, the autocorrelation function of the disturbed fluid velocity u˜_{θ}(z) is calculated for each node z within the flow domain 21 in a frequency range of 1420 Hz and 2840 Hz.

The autocorrelation function of an arbitrary function F_{θ} is defined by a following formula (1).

∥̅F̅_̅{̅θ̅}̅∥̅=∫_{θl}^{θh}F_{θ}F_{θ}*dθ (1)

Here, θₗ and θₕ in the above formula (1) represent a lower limit frequency and an upper limit frequency of the angular frequency band-of-interest, respectively, and F_{θ}* represents a complex conjugate of the function F_{θ}. That is, in the present specification, the autocorrelation function is defined as a “value obtained by integrating a product (mentioned later) of an arbitrary function F_{θ} and the complex conjugate function F_{θ}* thereof over an angular frequency band-of-interest”.

The operation part 14 stores the autocorrelation function of the disturbed fluid velocity u˜_{θ}(z) in the RAM, associating it with a coordinate of each node z. The autocorrelation function of the disturbed fluid velocity u˜_{θ}(z) is used when calculating the index (described later). The operation part 14 carries out a series of the process described above as the CFD calculation.

### (Calculation of APDS)

When defining a surface of the right-sided front side glass 22 of the vehicle model 20 as a “surface-to-be-analyzed”, a calculation formula of the index has been stored in advance in the RAM of the operation part 14, the index showing a quantitative relationship between the flow field within the flow domain 21 and the surface acoustic pressure fluctuation in the frequency band-of-interest on the surface-to-be-analyzed. In other words, it can be also said that this index shows how much “(a state of) the flow field at an arbitrary node z within the flow domain 21” contributes to the “surface acoustic pressure fluctuation pa_{θ}(x) in the frequency band-of-interest at an arbitrary surface node x (hereinafter, simply referred to as a “node x”) on the surface-to-be-analyzed”. When defining the ith node x which is counted from an arbitrary reference node on the surface-to-be-analyzed as xi (i: 1˜m) and defining the jth node z which is counted from an arbitrary reference node within the flow domain 21 as zj (j: 1˜n), the index for the kth node xk (k:1˜m) can be each calculated at all of the nodes zj within the flow domain 21.

A value obtained by a space integration of the index in the frequency band-of-interest for the node xk over the whole nodes zj within the flow domain 21 is an approximate value of the “autocorrelation function of the surface acoustic pressure fluctuation pa_{θ}(xk) in the frequency band-of-interest at the node xk” (described later). Therefore, it can be interpreted that the index value in the frequency band-of-interest at each node zj indicates an approximate value of the “autocorrelation function of the surface acoustic pressure fluctuation pa_{θ}(xk) in the frequency band-of-interest at the node xk” per unit volume of the flow domain 21. Therefore, hereinafter, the index in the frequency band-of-interest at each node zj will be also referred to as an “APDS (Acoustic Pressure Density Source)”. APDS (xk, zj) in the frequency band-of-interest is an index showing a degree of contribution of the “flow field at the node zj within the flow domain 21” to the “surface acoustic pressure fluctuation pa_{θ}(xk) in the frequency band-of-interest at the node xk on the surface-to-be-analyzed”. The degree of contribution becomes higher as the index value increases. A notation of a calculation formula of APDS and a method for deriving the calculation formula will be described later. Hereinafter, when there is no need to distinguish some node xk from another node xi, notations of “k” and “i” will be omitted. Same rule will be applied to the node zi. In addition, hereinafter, the surface acoustic pressure fluctuation in the frequency band-of-interest will be also simply referred to as a “surface acoustic pressure fluctuation” and the APDS in the frequency band-of-interest will be also simply referred to as “APDS”.

After the CFD calculation is finished, the operation part 14 performs, based on the calculation formula of APDS stored in the RAM, a calculation process of calculating APDS for a node xk at each node zj within the flow domain 21. The operation part 14 performs this calculation process for the whole nodes xi on the surface-to-be-analyzed. That is, the operation part 14 calculates n APDSs (the number of the nodes z) for a node xk and a total of mn APDSs. Now, a value of APDS (xk, zj) for a certain node xk is evaluated for every node zj. Therefore, hereinafter, the node z may be also referred to as an “evaluation point z”. The operation part 14 stores values of APDS (x, z) in the RAM thereof, associating each of the values with a corresponding coordinate of the node x and a corresponding coordinate of the evaluation point z. APDS is used when creating a distribution diagram of a predicted surface acoustic pressure fluctuation pa_{pθ} (x) (mentioned later) at a center frequency fₘ in the frequency band-of-interest as well as is used when creating an equivalent surface of the APDS (described later).

### (Calculation of Predicted Surface Acoustic Pressure Fluctuation and Instruction to Display a Distribution Diagram)

As mentioned above, a “value obtained by a space integration of the APDS for an arbitrary node x over the flow domain 21” is an approximate value of the “autocorrelation function of the surface acoustic pressure fluctuation pa_{θ} (x) at this node x”. Therefore, the operation part 14 extracts n APDSs (xk, zj) for a node xk out of mn APDSs (x, z) stored in the RAM to add up the extracted APDSs (xk, zj) (that is, perform a space integration of APDS (xk, zj) over the flow domain 21) and thereby calculates an approximate value of the autocorrelation function of the surface acoustic pressure fluctuation pa_{θ} (xk) at a node xk. Thereafter, the operation part 14 calculates (predicts), based on this approximated value, the surface acoustic pressure fluctuation pa_{θ} (xk) at a node xk. Hereinafter, the surface acoustic pressure fluctuation calculated (predicted) in this way may be referred to as a “predicted surface acoustic pressure fluctuation pa_{pθ}”. The operation part 14 performs this process for the whole nodes xi on the surface-to-be-analyzed. That is, the operation part 14 calculates m predicted surface acoustic pressure fluctuations pa_{pθ}s, where m is the number of the nodes x. The operation part 14 stores values of the predicted surface acoustic pressure fluctuation pa_{pθ}(x) in the RAM thereof, associating each of the values with a corresponding coordinate of the node x.

The operation part 14 creates, for each node x, data where the predicted surface acoustic pressure fluctuation pa_{pθ}(x) stored in the RAM is associated with a color data, colors therein varying depending on a magnitude of the value of the fluctuation pa_{pθ}(x) and transmits to the output part 16 a display instruction to display the created data on the display screen 18. The predicted surface acoustic pressure fluctuation pa_{pθ}(x) is associated with the thicker color data as the fluctuation pa_{pθ}(x) becomes larger. The output part 16 displays the data on the display screen 18 thereof upon reception of this display instruction.

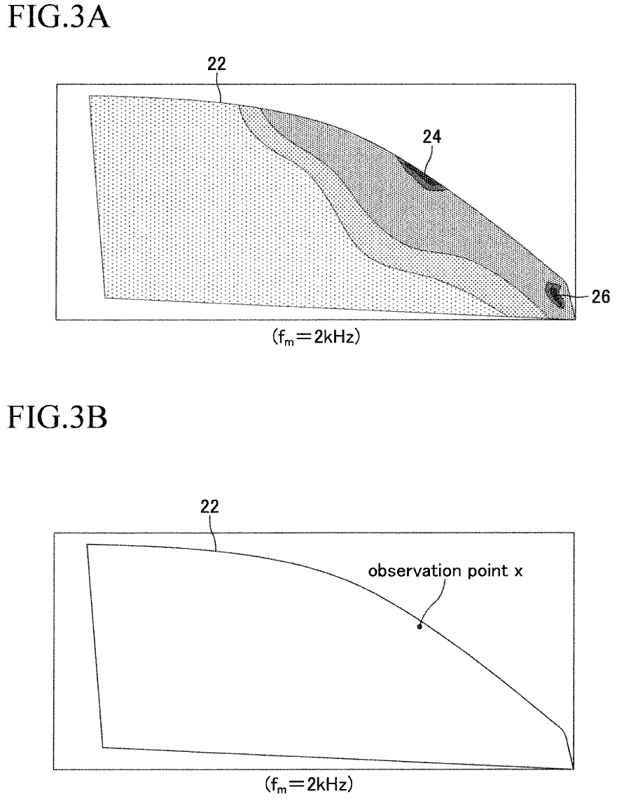

FIG. 3A shows one example of a distribution diagram of the predicted surface acoustic pressure fluctuation pa_{pθ}(x) on the surface-to-be-analyzed (the right-sided front side glass 22) displayed on the display screen 18 based on the display instruction. The frequency band-of-interest has been set to 2 kHz (that is, fₘ=2 kHz). The operator selects, based on this distribution diagram, a node x with a relatively large predicted surface acoustic pressure fluctuation pa_{pθ}(x). According to FIG. 3A, the predicted surface acoustic pressure fluctuation pa_{pθ}(x) is remarkable in a region 24 and a region 26 when the frequency band-of-interest is 2 kHz, and therefore the operator selects an arbitrary node from the nodes x within the regions 24 and 26. In this example, a node x in the region 24 is selected. The operator thereafter changes a shape of the vehicle model 20 for a purpose of reducing a surface acoustic pressure fluctuation at this node and observes a behavior of a predicted surface acoustic pressure fluctuation at this node. Hence, hereinafter, the aforementioned selected node may be also referred to as an “observation point x” (refer to FIG. 3B). The observation point x indicates a “position out of the positions on the surface-to-be-analyzed, the position causing large wind noise in the frequency band-of-interest”. When the observation point x is selected by the operator, the input part 12 inputs a coordinate data of this observation point x. The coordinate data input is stored in the RAM of the operation part 14. It should be noted that the observation point x corresponds to one example of a “target point-to-be-analyzed”.

### (Instruction to Display an APDS Equivalent Surface)

When the observation point x is selected, the operation part 14 extracts n APDSs (x, z) for the observation point x out of mn APDSs (x, z) stored in the RAM. The operation part 14 thereafter identifies APDS (x, z) having an arbitrary value set by the operator out of the extracted APDSs (x, z) and further extracts a coordinate of an evaluation point z which is associated with the identified APDS (x, z). Hereinafter, this arbitrary value may be also referred to as a “reference value” as will be described later. Next, the operation part 14 creates an equivalent surface data indicating an equivalent surface where the extracted evaluation points z are connected to each other and transmits to the output part 16 a display instruction to display the created equivalent surface data on the display screen 18. When receiving the display instruction, the output part 16 displays on the display screen 18 thereof the “equivalent surface data of the APDS having a reference value”. That is, when the observation point x is selected, the operation part 14 instructs the output part 16 to display on the display screen 18 a message to urge the operator to input a reference value of APDS. Thereby, an arbitrary reference value is input by the operator. The operation part 14 repeats the transmitting process of the aforementioned display instruction every time the reference value is input by the operator.

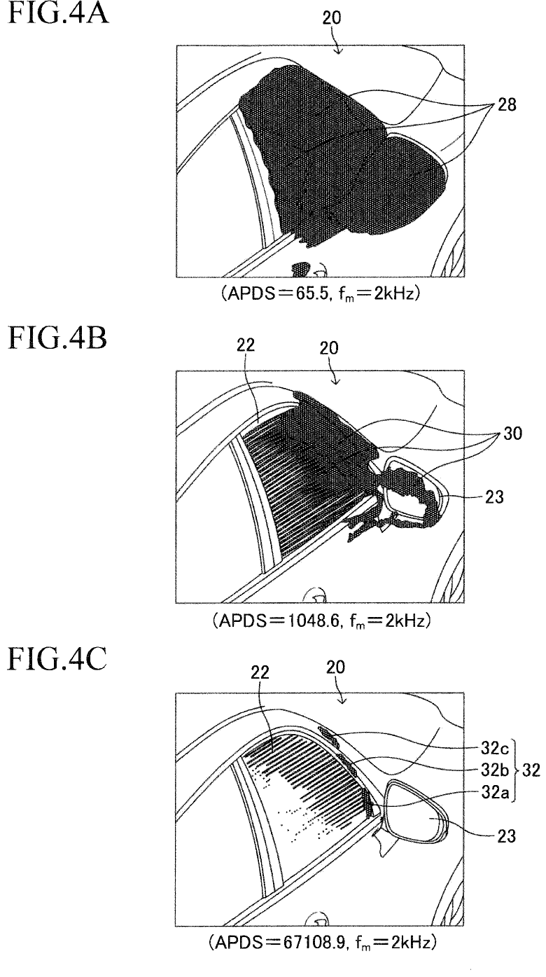

FIG. 4A to FIG. 4C show equivalent surfaces of APDS, reference values thereof being different from each other. FIG. 4A shows an equivalent surface 28 where the reference value is a criteria value (65.5 in this example). FIG. 4B shows an equivalent surface 30 where the reference value is 16 times as large as the criteria value (1048.6). FIG. 4C shows an equivalent surface 32 where the reference value is 256 times as large as the criteria value (67108.9). The frequency band-of-interest has been set to 2 kHz for each example. As shown in FIG. 4A to FIG. 4C, the equivalent surfaces 28, 30, and 32 are all closed surfaces. In addition, each equivalent surface 28, 30, and 32 has a plurality of independent equivalent surfaces. APDS (x, z) has a characteristic that APDS (x, z) becomes larger as a distance r from the observation point x (refer to FIG. 3B) to an evaluation point z becomes shorter. That is, the larger a value of APDS becomes, the closer the evaluation point z approaches the observation point x. Thus, as shown in FIG. 4A to FIG. 4C, surface areas of the equivalent surfaces 28, 30, and 32 become smaller as the reference values become larger. Besides, the equivalent surface 30 is included inside the equivalent surface 28 and the equivalent surface 32 is included inside the equivalent surface 30. That is, inside of some equivalent surface having a certain reference value, an equivalent surface having a larger reference value than the above reference value is included. Therefore, when a reference value gradually increases, a surface area of an equivalent surface gradually decreases, ending up in a couple of equivalent surfaces, each of which being apart from each other.

FIG. 4C shows one example of such a case. As shown in FIG. 4C, the equivalent surface 32 has three equivalent surfaces 32a, 32b, and 32c. It should be noted that strictly, FIG. 4C shows a plurality of linear equivalent surfaces on the right-sided front side glass 22. However, these equivalent surfaces are eliminated from the analysis in this example. According to FIG. 3B, among these three equivalent surfaces 32a to 32c, the equivalent surface 32b is the closest to the observation point x (that is, the distance r is the smallest), and the equivalent surface 32a is the farthest to the observation point x (that is, the distance r is the longest). Hence, it can be said that APDS of the equivalent surface 32b is strongly affected by the distance r compared to APDSs of the equivalent surfaces 32a or 32c (that is, a degree of contribution of the distance r to a value of APDS is high). Here, as mentioned above, APDS (x, z) includes following physical quantities as parameters, the physical quantities being an average fluid velocity U-(z), a disturbed fluid velocity u˜_{θ}(z), and an average vorticity Q-(z). The value of APDS becomes larger as these physical quantities become larger. Therefore, it can be interpreted that a reason why the “equivalent surfaces 32a or 32c, the distance r thereof being longer than the distance r of the equivalent surface 32b” has the same APDS as the equivalent surface 32b is because the APDS of the equivalent surfaces 32a or 32c is strongly affected by at least one of the above physical quantities (U-(z), u˜_{θ}(z), Q-(z)) compared to the APDS of the equivalent surface 32b (that is, because a degree of contribution of the above physical quantities to a value of APDS is high). In addition, it can be also interpreted that an equivalent surface with the longest distance r (the equivalent surface 32a in this example) is the most strongly affected by at least one of the above physical quantities (namely, a degree of contribution of the above physical quantities to a value of APDS is the highest).

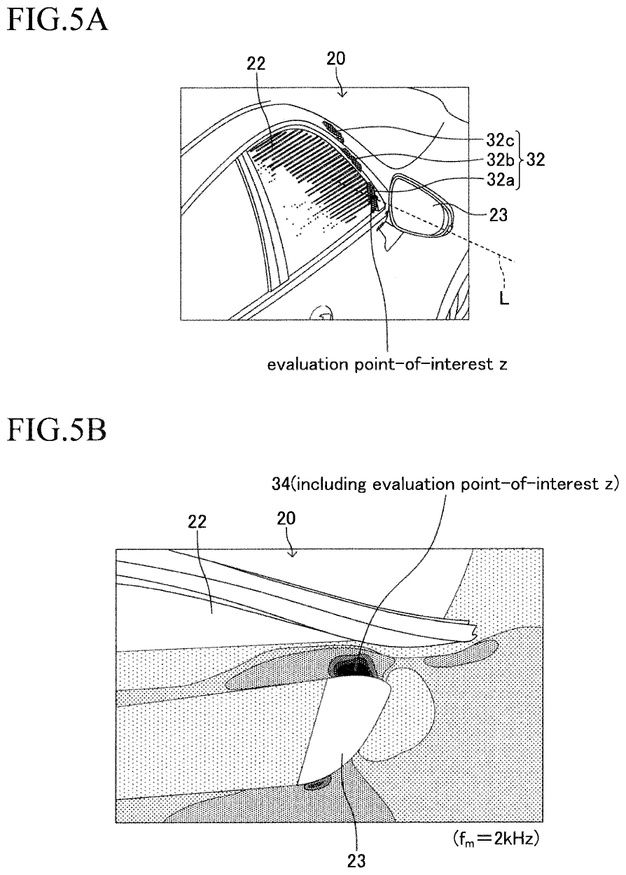

Therefore, the operator selects an arbitrary evaluation point z on the equivalent surface 32a having the longest distance r as an evaluation point z having a relatively large (substantially the largest) value of APDS. Hereinafter, the selected evaluation point z may be also referred to as an “evaluation point-of-interest z” (refer to FIG. 5A). The evaluation point-of-interest z indicates a “position among the flow field within the flow domain 21, the position having a relatively high (substantially the highest) degree of contribution to the predicted surface acoustic pressure fluctuation at the observation point x”. When the evaluation point-of-interest z is selected by the operator, the input part 12 inputs a coordinate data of this evaluation point-of-interest z. The coordinate data input is stored in the RAM of the operation part 14.

### (Instruction to Display APDS Parameters)

The operation part 14 selects the average fluid velocity U-(z), the disturbed fluid velocity u˜_{θ}(z), and the average vorticity Ω-(z) out of a plurality of parameters (physical quantities) constituting the APDS (x, z) at the evaluation point-of-interest z stored in the RAM and transmits to the output part 16 a display instruction to display these numerical data on the display screen 18. When receiving this display instruction, the output part 16 displays the numerical data of the selected parameters on the display screen 18 thereof. The operator thereafter identifies, based on the numerical data displayed, a parameter out of these parameters, the parameter having a relatively large contribution to the APDS value (that is, identifies a parameter causing a large APDS value). At this time, numerical data of parameters constituting APDS at other evaluation points z may be displayed as necessary. The operator may identify a parameter by comparing these numerical data. When the parameter is identified by the operator, the input part 12 inputs this parameter. The parameter input is stored in the RAM of the operation part 14. Hereinafter, this parameter may be also referred to as a “cause parameter”.

### (Instruction to Display a Distribution Diagram of a Physical Quantity)

The operation part 14 extracts a group of evaluation points z from the coordinate data of a group of evaluation points z stored in the RAM, the extracted group of the evaluation points z being positioned on a “plane (refer to a dashed line L in FIG. 5A) passing the evaluation point-of-interest z and parallel to an e1e2 plane (refer to FIG. 2A)”. The operation part 14 thereafter creates a distribution data indicating a distribution diagram of a cause parameter associated with the extracted group of evaluation points z and transmits to the output part 16 a display instruction to display the distribution diagram data created on the display screen 18. When receiving this display instruction, the output part 16 displays the data on the display screen 18 thereof. Hereinafter, a “plane passing the evaluation point-of-interest z and parallel to the e1e2 plane” may be also referred to as a “cross section-passing-the-evaluation-point-of-interest”.

FIG. 5B shows a distribution diagram of the average fluid velocity U-(z) [m/sec] in a case when the average fluid velocity U-(z) is identified as a cause parameter. As the average fluid velocity U-(z) becomes larger, the diagram is indicated in a thicker color. As shown in FIG. 5A, in this example, the evaluation point-of-interest z is positioned between a front part of the right-sided front side glass 22 and the right-sided side mirror 23, and thus a scope of the distribution diagram is set to be a scope including the front part of the right-sided front side glass 22 and the right-sided side mirror 23. It should be noted that at the positions of the right-sided front side glass 22 and the right-sided side mirror 23, images of the right-sided front side glass 22 and the right-sided side mirror 23, each of the images being a plan view of the vehicle model 20, are inserted, respectively. The evaluation point-of-interest z is included in a region 34 in FIG. 5B.

The operator analyses, based on the distribution diagram, a cause of the cause parameter (the average fluid velocity U-(z) in this example) being large at the evaluation point-of-interest z. In the example of FIG. 5B, the average fluid velocity U-(z) in the region 34 is remarkable, the region 34 being positioned in the vicinity of a vehicle body side of the right-sided side mirror 23. In general, a fluid velocity of the flow field becomes larger as air resistance becomes smaller. Therefore, it can be considered that air resistance in the region 34 during the vehicle traveling is small. Hence, the operator examines and changes a shape of the right-sided side mirror 23 in such a manner that the air resistance in the region 34 increases. Specific improved effects of the predicted surface acoustic pressure fluctuation pa_{pθ} (x) after the shape is changed will be described later.

The output part 16 displays, upon reception of a display instruction from the operation part 14, each data on the display screen 18. Details follow the description above. This is the description of a specific configuration of the present embodiment apparatus.

### <Derivation of a Calculation Formula of APDS>

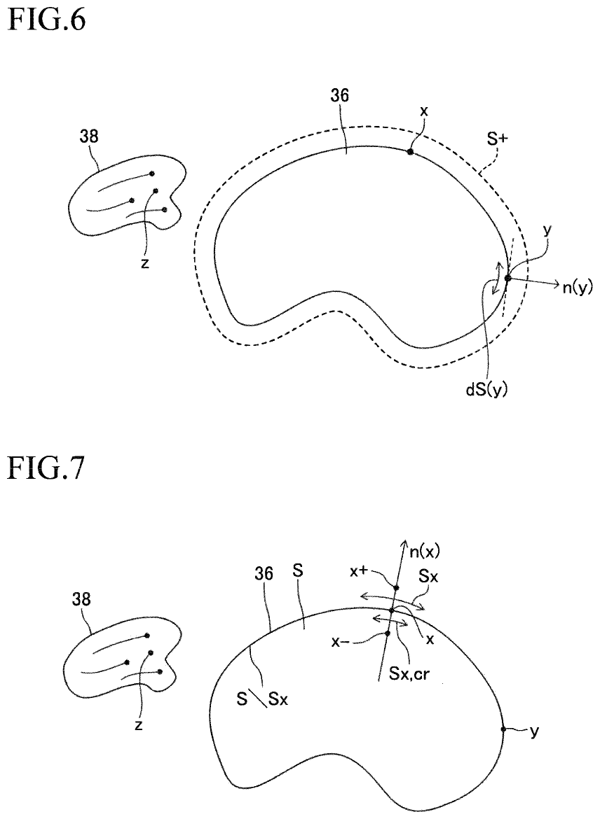

Next, a method for deriving a calculation formula of APDS mentioned above will be described using a rigid model. APDS is defined based on a formula where a “relational expression between the surface pressure fluctuation (that is, the sum of a surface acoustic pressure fluctuation and the surface convective pressure fluctuation) of a rigid model and the flow field around the rigid body” is converted from a time domain to a frequency domain, the relational expression being calculated based on a known Powell formula. Here, the above Powell formula is expressed in a form suitable to derive the APDS calculation formula. Therefore, hereinafter, a rigid model and a flow domain will be described first, referring to FIG. 6, followed by a description on derivation of a Powell formula in a form suitable to derive the APDS calculation formula. Next, derivation of a relational expression between the surface pressure fluctuation and the flow field in a time domain will be described, followed by derivation of the APDS calculation formula.

### (Rigid Model and Flow Domain)

FIG. 6 shows a schematic diagram of a rigid model 36 and a flow domain 38. The rigid model 36 (hereinafter, also referred to as a “rigid body 36”) includes an observation point x on a surface S thereof. The flow domain 38 is a part of the flow field around the rigid body 36, the part having a possibility of affecting the surface pressure fluctuation at the observation point x. The flow domain 38 includes a plurality of evaluation points z inside thereof. APDS (x, z) is an index showing a degree of contribution of the flow field at the evaluation point z to the surface acoustic pressure fluctuation at the observation point x. Other letters in FIG. 6 will be mentioned later.

### (Derivation of Powell Formula)

A following formula (2) shows a Navier-Stokes equation in a case of a volume force being zero.

$$ρ \frac{Du}{Dt} = - ∇ p + η {∇}^{2} u + \frac{η}{3} ∇ ( ∇ \cdot u ) \qquad ( 2 )$$

Here, ρ is a density of the flow field, u is a fluid velocity (vector amount) of the flow field, D/Dt is a material derivative, ρ is a pressure (pressure fluctuation, surface pressure fluctuation) on the surface of the rigid body 36, and n is a viscosity coefficient of the flow field.

When rewriting the material derivative in the above formula (2) using a partial derivative and deforming it using a following relational expression;

∇∧∇∧A=∇(∇·A)−∇²A

a following formula (3) can be obtained. Here, A in the above relational expression represents an arbitrary vector.

$$\frac{\partial u}{\partial t} + ( u \cdot ∇ ) u = - ∇ \int \frac{dp}{ρ} - v ( ∇ ∇ u - \frac{4}{3} ∇ ( ∇ \cdot u ) ) \qquad ( 3 )$$

Here, v is a dynamic viscosity coefficient of the flow field, satisfying a following relationship; v=η/ρ.

Subsequently, when rewriting the above formula (3) using following relational expressions;

$$( u \cdot ∇ ) u = ω u + ∇ ( \frac{1}{2} {u}^{2} )$$

$$ω = ∇ u$$

$$B = \int \frac{dp}{ρ} + \frac{1}{2} {u}^{2}$$

a following formula (4) can be obtained. Here, w is vorticity (vector amount) of the flow field and B is enthalpy.

$$\frac{\partial u}{\partial t} + ω u + ∇ B = - v ( ∇ ω - \frac{4}{3} ∇ ( ∇ \cdot u ) ) \qquad ( 4 )$$

The flow field in the present embodiment is non-compressible fluid or slightly compressible fluid, and thus a following relational expression;

∇·u<<∇∧ω

is satisfied. Hence, the above formula (4) can be approximated as shown in a following formula (5).

$$\frac{\partial u}{\partial t} + ω u + ∇ B = - v ( ∇ ω ) \qquad ( 5 )$$

When multiplying both sides of the above formula (5) with the density p of the flow field and thereafter taking a divergence thereof, a following formula (6) can be obtained.

$$∇ \cdot ( ρ \frac{\partial u}{\partial t} ) + ∇ \cdot ( ρ ∇ B ) = - ∇ \cdot ( ρω u ) ( ∵ ∇ \cdot ( ρ v \times ∇ ω ) = 0 ) \qquad ( 6 )$$

It should be noted that “x” in the above formula (6) represents a multiplication sign. Although the multiplication sign is basically omitted in the present specification, the sign will be exceptionally denoted when the sign promotes understanding.

Now, a relational expression shown in a following formula (7) is satisfied between the fluid velocity u of the flow field and the density p of the flow field.

$$∇ \cdot u = - \frac{1}{ρ} \frac{D ρ}{Dt} \qquad ( 7 )$$

When deforming a divergence (that is, a left side of a following formula (8)) of a product of “the density p of the flow field” and “a partial derivative of the fluid velocity u of the flow field with respect to time” by using the above formula (7), a right side of the following formula (8) can be obtained.

$$∇ \cdot ( ρ \frac{\partial u}{\partial t} ) = ∇ ρ \cdot \frac{\partial u}{\partial t} + ρ ( \frac{\partial }{\partial t} ( ∇ \cdot u ) ) = ∇ ρ \cdot \frac{\partial u}{\partial t} - ρ \frac{\partial }{\partial t} ( \frac{1}{ρ} \frac{D ρ}{Dt} ) = ∇ ρ \cdot \frac{\partial u}{\partial t} - ρ \frac{\partial }{\partial t} ( \frac{1}{ρ} \frac{\partial ρ}{\partial t} ) - ρ \frac{\partial }{\partial t} ( \frac{1}{ρ} ( u \cdot ∇ ) ρ ) = ∇ ρ \cdot \frac{\partial u}{\partial t} - ρ \frac{\partial }{\partial t} ( \frac{1}{ρ} \frac{\partial ρ}{\partial t} ) - ∇ ρ \cdot \frac{\partial u}{\partial t} - ρ u \cdot ∇ ( \frac{1}{ρ} \frac{\partial ρ}{\partial t} ) = - ρ \frac{D}{Dt} ( \frac{1}{ρ} \frac{\partial ρ}{\partial t} ) = - ρ \frac{D}{Dt} ( \frac{1}{ρ {c}^{2}} \frac{\partial p}{\partial t} ) \qquad ( 8 )$$

Here, c is acoustic velocity of the flow field. A following relationship is satisfied between the surface pressure fluctuation p, the density p of the flow field, and the acoustic velocity c of the flow field.

$$\frac{\partial p}{\partial ρ} = {c}^{2}$$

Now, the flow field in the present embodiment is a high Reynolds number flow (that is, flow with relatively large fluid velocity such as 100 km/h to 140 km/h). In the high Reynolds number flow, a following relational expression;

$$\frac{v}{{c}^{2}} u \cdot ( ∇ ω ) ≪ \frac{1}{{c}^{2}} \frac{DB}{Dt}$$

is satisfied. A Reynolds number Re is defined as Re=uL/v, where L represents a representative length of the flow field. When deforming a term in a parenthesis of the right side of the above formula (8) as shown below and applying the above relational expression, the term in the parenthesis of the right side of the formula (8) is approximated as shown in a following formula (9).

$$\frac{1}{ρ {c}^{2}} \frac{\partial ρ}{\partial t} = \frac{1}{{c}^{2}} \frac{\partial B}{\partial t} - \frac{1}{{c}^{2}} u \cdot ( \frac{\partial u}{\partial t} ) = \frac{1}{{c}^{2}} \frac{\partial B}{\partial t} - \frac{1}{{c}^{2}} u \cdot ( - ω u - ∇ B - v ( ∇ ω ) ) ( ∵ the formula ( 5 ) ) = \frac{1}{{c}^{2}} \frac{DB}{Dt} + \frac{v}{{c}^{2}} u \cdot ( ∇ ω ) ( ∵ \frac{1}{{c}^{2}} u \cdot ( - ω u ) = 0 ) \text{\textasciitilde} \frac{1}{{c}^{2}} \frac{DB}{Dt} \qquad ( 9 )$$

When deforming (approximating) the above formula (6) using the above formulae (8) and (9), a following formula (10) can be obtained.

$$\frac{D}{Dt} ( \frac{1}{{c}^{2}} \frac{DB}{Dt} ) - \frac{1}{ρ} ∇ \cdot ( ρ ∇ ) B = \frac{1}{ρ} ∇ \cdot ( ρω u ) \qquad ( 10 )$$

The flow field in the present embodiment is a low Mach number flow (that is, flow field where a ratio of the fluid velocity of fluid to the acoustic velocity is relatively low). In the low Mach number flow, following relational expressions are satisfied.

$$c \text{\textasciitilde} {c}_{0}$$

$$ρ \text{\textasciitilde} {ρ}_{0}$$

$$\frac{1}{c} \frac{D}{Dt} = \frac{1}{c} \frac{\partial }{\partial t} + \frac{u}{c} \cdot ∇ \text{\textasciitilde} \frac{1}{c} \frac{\partial }{\partial t} ( ∵ u ≪ c )$$

Therefore, when deforming the above formula (10) using these relational expressions, the Powell formula as shown in a following formula (11) can be obtained. It should be noted that cₒ and ρₒ in the above relational expression represent an acoustic velocity of the flow field in a static state and a density of the flow field in the static state, respectively.

$$( \frac{1}{{c}_{0}^{2}} \frac{{\partial }^{2}}{\partial {t}^{2}} - {∇}^{2} ) B = ∇ \cdot ( ω u ) \qquad ( 11 )$$

### (Derivation of a Relational Expression Between the Surface Pressure Fluctuation and the Flow Field in the Time Domain)

Green function G satisfies a relational expression of a following formula (12).

$$( \frac{1}{{c}_{0}^{2}} \frac{{\partial }^{2}}{\partial {t}^{2}} - {∇}^{2} ) G ( x , z , t - τ ) = δ ( x - z ) δ ( t - τ ) \qquad ( 12 )$$

Here, the observation point x and the evaluation point z follow the description made earlier (refer to FIG. 6). τ represents a past time. δ(x) is a Dirac delta function. In addition, the Green function G in the above formula (12) is expressed as shown in a following formula (13) in a free space.

$$G ( x , z , t - τ ) = \frac{δ ( t - τ - \frac{\vert x - z \vert}{c} )}{4 π \vert x - z \vert} \qquad ( 13 )$$

Taking an object boundary condition into account, the Powell formula as shown in the above formula (11) is expressed as shown in a following formula (14).

$$H ( \frac{1}{{c}^{2}} \frac{{\partial }^{2}}{\partial {t}^{2}} - {∇}^{2} ) B = H ∇ \cdot ( ω u ) \qquad ( 14 )$$

H(z) is a Heaviside Unit function and is defined by a following formula (15).

$$H ( z ) = \{ \begin{matrix}1 & ( z in V ) \\ 0 & ( z inside S \text{+} )\end{matrix} \qquad ( 15 )$$

Here, as shown in FIG. 6, V is a bulk to indicate the flow domain 38 and S+ is a virtual surface surrounding the surface S of the rigid body 36. “z in V” in the above formula (15) indicates a case when the evaluation point z is positioned inside the flow domain 38 whereas “z inside S+” indicates a case when the evaluation point z is positioned inside the virtual surface S+.

The Heaviside function H(z) satisfies an integral equation of a following formula (16).

∫_{V}(⋅)∇Hd³z=∫_{S+}(⋅)ndS (16)

Here, (⋅) in the formula represents an inner product with an arbitrary value. Besides, as shown in FIG. 6, the rigid body 36 includes an evaluation point y on the surface S at a different position from the observation point x. n in the formula represents a normal vector n(y) at the evaluation point y whereas dS represents a surface area dS(y) in the vicinity of the evaluation point y.

The first term and the second term of the left side of the above formula (14) and the right side of the formula (14) can be deformed as shown in following formulae (14-1), (14-2), and (14-3), respectively.

$$\begin{matrix}H \frac{1}{{c}^{2}} B = \frac{1}{{c}^{2}} \frac{{\partial }^{2}}{\partial {t}^{2}} HB & ( \text{14-1} ) \\ H {∇}^{2} B = {∇}^{2} HB - ∇ \cdot ( B ∇ H ) - ∇ H \cdot ∇ B & ( \text{14-2} ) \\ H ∇ \cdot ( ω u ) = ∇ \cdot ( H ω u ) - ∇ H \cdot ( ω u ) & ( \text{14-3} )\end{matrix}$$

When substituting the above formula (14) with the above formulae (14-1), (14-2), and (14-3), a following formula (17) can be obtained.

$$( \frac{1}{{c}^{2}} \frac{{\partial }^{2}}{\partial {t}^{2}} - {∇}^{2} ) HB = - ∇ \cdot ( B ∇ H ) - ∇ H \cdot ( ∇ B + ω u ) + ∇ \cdot ( H ω u ) \qquad ( 17 )$$

The second term (A negative sign is omitted) of the right side of the above formula (17) can be deformed as shown in a following formula (17-1).

$$∇ H \cdot ( ∇ B + ω u ) = - ∇ H \cdot ( \frac{\partial u}{\partial t} + v ( ∇ ω ) ) = - ∇ H \cdot \frac{\partial u}{\partial t} - v ∇ \cdot ( ∇ H ω ) \qquad ( \text{17-1} )$$

When substituting the above formula (17) with the above formula (17-1), a following formula (18) can be obtained.

$$( \frac{1}{{c}^{2}} \frac{{\partial }^{2}}{\partial {t}^{2}} - {∇}^{2} ) HB = - ∇ \cdot ( B ∇ H ) - ∇ H \cdot ( \frac{\partial u}{\partial t} ) + v ∇ \cdot ( ∇ H ω ) + ∇ \cdot ( H ω u ) \qquad ( 18 )$$

By using the above formula (13), an integral notation in the above formula (18) is rewritten as shown in a following formula (19).

$$HB ( x , t ) = {\int }_{- ∞}^{∞} {\int }_{V} G ( x , z , t - τ ) \{ \begin{matrix}- ∇ \cdot ( B ∇ H ) + ∇ H \cdot ( \frac{\partial u}{\partial t} ) + v ∇ \cdot ( ∇ H ω ) \\ + ∇ \cdot ( H ω u )\end{matrix} \} {d}^{3} zd τ \qquad ( 19 )$$

When expanding the first term of the right side of the above formula (19) using the above formula (18), a following formula (19-1) can be obtained. It should be noted that hereinafter, an integration by time will be omitted for a purpose of notation when describing the deformation of each term of the right side of the above formula (19).

∫_{V}G(x,z,t−τ)(−∇·(B∇H))d³z=∫_{V}{−∇·(GB∇H)+B∇G·∇H}d³z= [symbol] _{S+}−GB∇H·ndS+∫_{V}{B∇G·∇H}d³z= [symbol] _{S+}B∇G·ndS (19-1)

When expanding the second term and the third term of the right side of the above formula (19) by using the above formula (18), a following formula (19-2) can be obtained.

$${\int }_{V} G ( x , z , t - τ ) ( \frac{\partial u}{\partial t} \cdot ∇ H + v ∇ \cdot ( H ω u ) ) {d}^{3} z \\ = {∮}_{S +} G ( x , y , t - τ ) \frac{\partial u}{\partial t} \cdot ndS - {\int }_{V} v ∇ G \cdot ( ∇ H ω ) {d}^{3} z \\ = {∮}_{S +} G ( x , y , t - τ ) \frac{\partial u}{\partial t} \cdot ndS - {\int }_{V} v ∇ H \cdot ( ∇ G ω ) {d}^{3} z \\ = {∮}_{S +} G ( x , y , t - τ ) \frac{\partial u}{\partial t} \cdot ndS + {∮}_{S +} v ( ω ∇ G ) \cdot ndS \qquad ( \text{19-2} )$$

The fourth term of the right side of the above formula (19) can be deformed as shown in a following formula (19-3).

∫_{V}G(x,z,t−τ)∇·(Hω [symbol] u)d³z=∫_{V}{∇·(HGω [symbol] u)−∇G·(Hω [symbol] u)}d³z= [symbol] _{S+}G(Hω [symbol] u)·ndS−∫_{V}∇G·(Hω [symbol] u)d³z=−∫_{V}∇G·(Hω [symbol] u)d³z (19-3)

When substituting the above formula (19) with the above formulae (19-1) to (19-3), a following formula (20) can be obtained.

HB(x,t)=∫_{-∞}^{∞} [symbol] _{S+}B∇G·ndSdτ+∫_{-∞}^{∞} [symbol] _{S+}G(x,y,t−τ)∂u/∂t·ndSdτ+∫_{-∞}^{∞} [symbol] _{S+}v(ω [symbol] ∇G)·ndSdτ−∫_{-∞}^{∞}∫_{V}∇G·(Hω [symbol] u)d³zdτ (20)

When making the virtual surface S+ converge to the surface S of the rigid body 36, the above formula (20) can be rewritten as shown in a following formula (21).

HB(x,t)=∫_{-∞}^{∞} [symbol] _{S}B∇G·ndSdτ+∫_{-∞}^{∞} [symbol] _{S}G(x,y,t−τ)∂u/∂t·ndSdτ+∫_{-∞}^{∞} [symbol] _{S}v(ω [symbol] ∇G)·ndSdτ−∫_{-∞}^{∞}∫_{V}∇G·(Hω [symbol] u)d³zdτ (21)

Here, in the high Reynolds number flow, the third term of the right side of the above formula (21) is negligibly small compared to the fourth term. In addition, since the fluid velocity is zero when the rigid body 36 is in a static state, the second term of the right side is equal to zero. Accordingly, the above formula (21) can be simplified as shown in a following formula (22).

(∴ formula(15)) (22)

There is no fluid velocity on a surface of a static object, and thus the enthalpy B is expressed as shown in a following formula.

$$B = \int \frac{dp}{ρ} + \frac{1}{2} {u}^{2} = \frac{p}{ρ}$$

When defining the right side p/ρ in the above formula as p/ρ=p* and substituting the above formula (22) with the enthalpy B, a relational expression of a following formula (23) can be obtained. This relational expression is a “relational expression between the surface pressure fluctuation and the flow field in the time domain”.

p_{*}(x,t)=∫_{-∞}^{∞} [symbol] _{S}p_{*}(y,τ)∇G(x,y,t−τ)·n(y)dSdτ−∫_{-∞}^{∞}∫_{V}(ω∧u)(z,τ)·∇G(x,z,t−τ)d³zdτ (23)

(Derivation of APDS calculation formula)

The relational expression of the above formula (23) includes in both sides thereof a value (function) p_{*}(=p/ρ) based on the surface pressure fluctuation p, and thus it is impossible to directly calculate the surface pressure fluctuation p at the observation point x from the fluid velocity u and the vorticity w. Therefore, hereinafter, a term including p* will be eliminated from the right side by deformation, and a relational expression between the “surface pressure fluctuation p at the observation point x” and “the fluid velocity u and the vorticity ω of the flow field” will be derived.

As shown in FIG. 7, let us define a region in the vicinity of the observation point x on the surface S of the rigid body 36 as a surface region Sx. A normal vector of the surface region Sx is denoted as n(x). The surface region Sx is a sufficiently large plane. In addition, let us define two points x+ and x− on the normal vector n(x), each of which being an equal distance from the observation point x. The point x+ is positioned outside the rigid body 36 and the point x− is positioned inside the rigid body 36. Other letters will be described later. When substituting the above formula (22) with the points x+ and x− as observation points, following formulae (22-1) and (22-2) can be obtained.

HB(x+,t)=∫_{-∞}^{∞} [symbol] _{S}B(y,τ)∇G(x+,y,t−τ)·n(y)dSdτ−∫_{-∞}^{∞}∫_{V}(ω [symbol] u)(z,τ)·∇G(x+,z,t−τ)d³zdτ (22-1)

HB(x−,t)=∫_{-∞}^{∞} [symbol] _{S}B(y,τ)∇G(x−,y,t−τ)·n(y)dSdτ−∫_{-∞}^{∞}∫_{V}(ω [symbol] u)(z,τ)·∇G(x−,z,t−τ)d³zdτ (22-2)

When combining each of the both sides of the formula (22-1) with the corresponding side of the formula (22-2) and taking a limit thereof of when x− and x+ approach x, a following formula (24) can be obtained. It should be noted that the following deformation makes use of following relational expressions, that is, H(x+)=1 and H(x−)=0 (refer to the formula (15)).

$${p}_{*} ( x , t ) = {lim}_{( x + , x - ) \to x} HB ( x + , t ) = {lim}_{( x + , x - ) \to x} ( HB ( x + , t ) + HB ( x - , t ) ) = {lim}_{( x + , x - ) \to x} {\int }_{- ∞}^{∞} {∮}_{S} B ( y , τ ) ( ∇ G ( x + , y , t - τ ) + ∇ G ( x - , y , t - τ ) ) \cdot n ( y ) dSd τ - {lim}_{( x + , x - ) \to x} {\int }_{- ∞}^{∞} {\int }_{V} ( ω u ) ( z , τ ) \cdot ( ∇ G ( x + , z , t - τ ) + ∇ G ( x - , z , t - τ ) ) {d}^{3} zd τ \qquad ( 24 )$$

The first and the second terms of the right side of the above formula (24) can be deformed as shown in following formulae (24-1) and (24-2), respectively. S\Sx in the formula indicates a part out of the surface S of the rigid body 36, the part not including the surface region Sx (refer to FIG. 7).

$$\begin{matrix}{lim}_{( x + , x - ) \to x} {\int }_{- ∞}^{∞} {∮}_{S} B ( y , τ ) ( ∇ G ( x + , y , t - τ ) + ∇ G ( x - , y , t - τ ) ) \cdot n ( y ) dSd τ = {lim}_{( x + , x - ) \to x} {\int }_{- ∞}^{∞} {∮}_{Sx} B ( x , τ ) ( ∇ G ( x + , x , t - τ ) + ∇ G ( x - , x , t - τ ) ) \cdot n ( x ) dSd τ + {lim}_{( x + , x - ) \to x} {\int }_{- ∞}^{∞} {∮}_{S \backslash Sx} B ( y , τ ) ( ∇ G ( x + , y , t - τ ) + ∇ G ( x - , y , t - τ ) ) \cdot n ( y ) dSd τ = {\int }_{- ∞}^{∞} {∮}_{S \backslash Sx} 2 {p}_{*} ( y , τ ) ∇ G ( x + , y , t - τ ) \cdot n ( y ) dSd τ & ( \text{24-1} ) \\ {lim}_{( x + , x - ) \to x} {\int }_{- ∞}^{∞} {\int }_{V} ( ω u ) ( z , τ ) \cdot ( ∇ G ( x + , z , t - τ ) + ∇ G ( x - , z , t - τ ) ) {d}^{3} zd τ = {\int }_{- ∞}^{∞} {\int }_{V} 2 ( ω u ) ( z , τ ) \cdot ∇ G ( x - , z , t - τ ) {d}^{3} zd τ & ( \text{24-2} )\end{matrix}$$

When substituting the above formula (24) with the above formulae (24-1) and (24-2), a following formulae (25) can be obtained.

p_{*}(x,t)=∫_{-∞}^{∞} [symbol] _{S\Sx}2p_{*}(y,τ)∇G(x,y,t−τ)·n(y)dSdτ−∫_{-∞}^{∞}∫_{V}2(ω [symbol] u)(z,τ)·∇G(x,z,t−τ)d³zdτ (25)

Fourier transform is defined by a following formula.

A_{θ}(x)=−∫_{-∞}^{∞}A(x,t)e^{-iθt}dt

Here, A_{θ}(x) in the formula represents a magnitude (amplitude) of a function A (x, t) at an angular frequency θ. A_{θ}(x) is a complex number and a complex conjugate thereof A_{θ}*(x) satisfies a relational expression of a following formula (26).

A_{θ}*(x)=A_{-θ}(x)=−∫_{-∞}^{∞}A(x,t)e^{iθt}dt (26)

When performing the Fourier transform on the above formula (24) and using a result of the Fourier transform of a convolution integration, a following formula (27) can be obtained.

p_{*θ}(x)= [symbol] _{S\Sx}2p_{*θ}(y)∇G_{θ}(x,y)·n(y)dS−∫_{V}2(ω [symbol] u)_{θ}(z)·∇G_{θ}(x,z)d³z (27)

Here, a function G_{θ} (x, z) obtained by performing the Fourier transform on the Green function G is expressed as shown in a following formula (28) and satisfies a relational expression (so called Helmholtz equation) of a following formula (29).

$${G}_{θ} ( x , z ) = \frac{- {e}^{- i θ \frac{\vert x - z \vert}{{c}_{0}}}}{4 π \vert x - z \vert} = \frac{- {e}^{- {ik}_{0} r}}{4 π r} \qquad ( 28 )$$

(Δ+k₀²)G_{θ}(x,z)=δ(x−z) (29)

Here, k₀ represents a wave number of a component of an angular frequency θ (so called an acoustic wave number) and k₀=θ/c₀ is satisfied. r is a distance between the observation point x and the evaluation point z.

A gradient of G_{θ} (x, z) can be expressed as shown in a following formula (30) using the above formula (28). A vector r in the formula is a vector from the observation point x toward the evaluation point z.

$$( 30 )$$

$$∇ {G}_{θ} ( x , z ) = ∇ \frac{- {e}^{- {ik}_{0} r}}{4 π r} = \frac{( {ik}_{0} r + 1 ) - {e}^{- {ik}_{0} r}}{4 π {r}^{2}} \times ∇ r = \frac{( {ik}_{0} r + 1 ) - {e}^{- {ik}_{0} r}}{4 π {r}^{2}} \times \frac{\vec{r}}{r}$$

Here, a pressure generated on the surface of the rigid body 36 is composed of the fluctuation in the convective pressure and the acoustic pressure. The fluctuation in the convective pressure is transmitted at a fluid current velocity and is not transmitted very far and thus satisfies an acoustic compact condition (k₀r<<1). Hence, a part of a gradient of G_{θ} (x, z) in the above formula (30), the part contributing to the fluctuation in the surface convective pressure is independent from the angular frequency θ as shown in a following formula (30-1) and only a function of the distance r can be approximated.

$$∇ {G}_{θ} ( x , z ) \approx \frac{- {e}^{- {ik}_{0} r}}{4 π {r}^{2}} \times \frac{\vec{r}}{r} \approx \frac{1}{4 π {r}^{2}} \times \frac{\vec{r}}{r} \qquad ( \text{30-1} )$$

On the other hand, the acoustic pressure is transmitted at an acoustic velocity in a far distance and thus does not satisfy the acoustic compact condition (that is, k₀r>>1 is satisfied at a distant point). Therefore, a part of the gradient of G_{θ} (x, z) in the above formula (30), the part contributing to the surface acoustic pressure fluctuation is expressed as shown in a following formula (30-2).

$$∇ {G}_{θ} ( x , z ) \approx \frac{{ik}_{0} {re}^{- {ik}_{0} r}}{4 π {r}^{2}} \times \frac{\vec{r}}{r} = \frac{{ik}_{0} {e}^{- {ik}_{0} r}}{4 π r} \times \frac{\vec{r}}{r} \qquad ( 30 \text{-} 2 )$$

An autocorrelation function (refer to the above formula (1)) of a “function p*_{θ}(x) based on the surface pressure fluctuation p_{θ}(x) at the observation point x”, the function being the left side of the above formula (27) can be expressed as shown in a following formula (31).

∫_{θl}^{θh}p_{*θ}*(x)p_{*θ}(x)dθ=∫_{θl}^{θh} [symbol] _{S\Sx}2p_{*θ}(y)p_{*θ}*(x)∇G_{θ}(x,y)·n(y)dSdθ−∫_{θl}^{θh}∫_{V}2p_{*θ}*(x)(ω [symbol] u)_{θ}(z)·∇G_{θ}(x,z)d³zdθ (31)

The above formula (31) can be expressed as shown in a following formula (32) using the acoustic compact condition of the gradient of G_{θ} (x, z) (refer to the formula (30)).

∫_{θl}^{θh}p_{*θ}(x)p_{*θ}*(x)dθ= [symbol] _{S\Sx}(∫_{θl}^{θh}2p_{*θ}(y)p_{*θ}*(x)dθ)∇G_{θ}(x,y)·n(y)dS−∫_{θl}^{θh}∫_{V}2p_{*θ}*(x)(ω [symbol] u)_{θ}(z)·∇G_{θ}(x,z)d³zdθ (32)

Here, let us define a correlation distance I_{x,cr}, a correlation area S_{x,cr} (refer to FIG. 7), and a correlation volume V_{x, cr} of a physical quantity at an arbitrary observation point x in an angular frequency band-of-interest [θₗ, θₕ] as following formulae (33-1), (33-2), and (33-3), respectively. It should be noted that θₘ in the formula is a center angular frequency in the angular frequency band-of-interest (θₘ=2πfₘ).

$$\begin{matrix}{l}_{x , cr} \text{\textasciitilde} \frac{\overline{U} ( x )}{{θ}_{m}} & ( 33 \text{-} 1 ) \\ {S}_{x , cr} \text{\textasciitilde} {l}_{x , cr}^{2} & ( 33 \text{-} 2 ) \\ {V}_{x , cr} \text{\textasciitilde} {l}_{x , cr}^{3} & ( 33 \text{-} 3 )\end{matrix}$$

That is, the correlation area S_{x,cr} is proportional to a square of the average fluid velocity and the correlation volume V_{x, cr} is proportional to a cube of the average fluid velocity.

The angular frequency band-of-interest in the present embodiment is relatively large, and thus the correlation distance I_{x,cr} is relatively small. Accordingly, the correlation area S_{x,cr} and the correlation volume V_{x, cr} are relatively small as well. Therefore, as shown in FIG. 7, the correlation area S_{x,cr} is included inside the surface region Sx (S_{x,cr}⊂Sx). Now, a term to be integrated of the first term of the right side of the above formula (32) includes the evaluation point y on the surface S of the rigid body 36 and is integrated over a region excluding the surface region Sx out of the surface S (S\Sx). Hence, a physical quantity at the observation point x has no correlation with a physical quantity at the evaluation point y, and as a result, the first term of the right side of the above formula (32) becomes equal to zero.

In addition, hereinafter, a product of an arbitrary function F_{θ} and a complex conjugate function F_{θ}* thereof will be referred to as a “norm of a function F_{θ}”, which will be defined as shown in a following formula (34).

∥F_{θ}∥=F_{θ}F_{θ}* (34)

That is, the autocorrelation function (refer to the formula (1)) is a value obtained by integrating a norm of an arbitrary function F_{θ} in the angular frequency band-of-interest.

Thereby, the above formula (32) can be expressed as shown in a following formula (35).

∫_{θl}^{θh}∥p_{*θ}(x)∥dθ=∫_{θl}^{θh}p_{*θ}*(x)dθ=−∫_{θl}^{θh}p_{*θ}*(x)∫_{V}2(ω [symbol] u)_{θ}(z)·∇G_{θ}(x,z)d³zdθ (35)

According to the above formula (35), the surface pressure fluctuation p_{θ} (x) at the observation point x in the angular frequency band-of-interest depends on an outer product of the vorticity w and the fluid velocity u in the flow field in the flow domain 38. The inventor of the present application focused on this point and considered that reduction in a value of the autocorrelation function of the space integration of the right side of the above formula (35) enables to reduce the surface pressure fluctuation p_{θ}(x) at the observation point x, leading to reduction in the surface acoustic pressure fluctuation pa_{θ}(x) as well. This autocorrelation function can be deformed as shown in a following formula (36).

$${\int }_{θ l}^{θ h} ‖ {\int }_{V} 2 {( ω u )}_{θ} ( z ) \cdot ∇ {G}_{θ} ( x , z ) {d}^{3} z ‖ d θ = {\int }_{θ l}^{θ h} {\int }_{V} {\int }_{V} {4 [ {( ω u )}_{θ} ( {z}_{1} ) \cdot ∇ {G}_{θ} ( x , {z}_{1} ) ] [ {( ω u )}_{θ} ( {z}_{2} ) \cdot ∇ {G}_{θ} ( x , {z}_{2} ) ]}^{*} {d}^{3} {z}_{1} {d}^{3} {z}_{2} d θ ) = {\int }_{V} {\int }_{V} {\int }_{θ l}^{θ h} {4 [ {( ω u )}_{θ} ( {z}_{1} ) \cdot ∇ {G}_{θ} ( x , {z}_{1} ) ] [ {( ω u )}_{θ} ( {z}_{2} ) \cdot ∇ {G}_{θ} ( x , {z}_{2} ) ]}^{*} d θ {d}^{3} {z}_{1} {d}^{3} {z}_{2} \qquad ( 36 )$$

Here, z1 and z2 in the formula is an arbitrary evaluation point in the flow domain 38 and they are not equal with each other. A correlation between a physical quantity at the evaluation point z1 and a physical quantity at the evaluation point z2 in the angular frequency band-of-interest can be ignored when the evaluation point z1 is not included in the correlation volume V_{x, cr} of the evaluation point z2. Therefore, the above formula (36) can be further deformed as shown in a following formula (37).

∫_{θl}^{θh}∥∫_{V}2(ω [symbol] u)_{θ}(z)·∇G_{θ}(x,z)d³z∥dθ=∫_{V}∫_{θl}^{θh}∥2(ω [symbol] u)_{θ}(z₂)·∇G_{θ}(x,z₂)∥dθ×V_{z}_{₂}_{,cr}d³z₂ (37)

A part of a “part to be integrated over the angular frequency band-of-interest” of the right side of the above formula (37), the part contributing to the surface acoustic pressure fluctuation can be approximated as shown in a following formula (38) using the above formula (30-2).

$${\int }_{θ l}^{θ h} ‖ 2 {( ω u )}_{θ} ( {z}_{2} ) \cdot ∇ {G}_{θ} ( x , {z}_{2} ) ‖ d θ \approx {\int }_{θ l}^{θ h} ‖ 2 {( ω u )}_{θ} ( {z}_{2} ) \cdot \frac{{ik}_{0} {e}^{- {ik}_{0} r}}{4 π r} \times \frac{\vec{r}}{r} ‖ d θ = {\int }_{θ l}^{θ h} ‖ 2 {( ω u )}_{θ} ( {z}_{2} ) \cdot \frac{{k}_{0}}{4 π r} \times \frac{\vec{r}}{r} ‖ d θ \qquad ( 38 )$$

As shown in following formulae (39-1) and (39-2), the fluid velocity u in the above formula (38) can be decomposed into the average fluid velocity U- as an average component and the disturbed fluid velocity u˜ as a disturbed component and the vorticity w can be decomposed into the average vorticity Ω- as an average component and a disturbed vorticity w˜ as a disturbed component.

u=Ū+ũ (39-1)

ω=Ω̅+\tilde{ω} (39-2)

In addition, in a spatial coordinate system of the rigid body 36, let us define a vector r as shown in a following formula (40).

\vec{r}=(r1,r2,r3) (40)

Here, assuming that the observation point x is an origin, r1, r2, and r3 are an e1 component, an e2 component, and an e3 component of the vector r, respectively.

When substituting the right side of the above formula (38) with these formulae (39-1), (39-2), and (40), this right side can be deformed as shown in a following formula (41). It should be noted that a product of the disturbed components is negligibly small and thus the description of the product thereof is omitted in the following formula (41).

$${\int }_{θ l}^{θ h} ‖ 2 {( ω u )}_{θ} ( {z}_{2} ) \cdot \frac{{k}_{0}}{4 π {r}^{2}} \times \frac{\vec{r}}{r} ‖ d θ = \frac{{k}_{0}^{2}}{16 {π}^{2} {r}^{2}} {\int }_{θ l}^{θ h} ‖ 2 ( \overline{Ω} {\tilde{u}}_{θ} ) ( {z}_{2} ) \cdot \frac{\vec{r}}{r} + 2 ( {\tilde{ω}}_{θ} \overline{U} ) ( {z}_{2} ) \cdot \frac{\vec{r}}{r} ‖ d θ = \frac{{k}_{0}^{2}}{4 {π}^{2} {r}^{4}} {\int }_{θ l}^{θ h} ‖ ( {\overline{Ω}}_{e 2} \times {\tilde{u}}_{e 3 θ} ) r 1 - ( {\overline{Ω}}_{e 3} \times {\tilde{u}}_{e 2 θ} ) r 1 + ( {\overline{Ω}}_{e 3} \times {\tilde{u}}_{e 1 θ} ) r 2 - ( {\overline{Ω}}_{e 1} \times {\tilde{u}}_{e 3 θ} ) r 2 + ( {\overline{Ω}}_{e 1} \times {\tilde{u}}_{e 2 θ} ) r 3 - ( {\overline{Ω}}_{e 2} \times {\tilde{u}}_{e 1 θ} ) r 3 + ( {\overline{U}}_{e 3} \times {\tilde{ω}}_{e 2 θ} ) r 1 - ( {\overline{U}}_{e 2} \times {\tilde{ω}}_{e 3 θ} ) r 1 + ( {\overline{U}}_{e 1} \times {\tilde{ω}}_{e 3 θ} ) r 2 - ( {\overline{U}}_{e 3} \times {\tilde{ω}}_{e 1 θ} ) r 2 + ( {\overline{U}}_{e 2} \times {\tilde{ω}}_{e 1 θ} ) r 3 - ( {\overline{U}}_{e 1} \times {\tilde{ω}}_{e 2 θ} ) r 3 ‖ d θ \qquad ( 41 )$$

Now, let us define a correlation function of two arbitrary functions E_{θ} and F_{θ} in the angular frequency band-of-interest as shown in a following formula (42).

E̅_̅{̅θ̅}̅F̅_̅{̅θ̅}̅=∫_{θl}^{θh}E_{θ}F_{θ}*dθ (42)

According to a vortex uniform isotropic hypothesis, relational expressions shown in following formulae (43-1) to (43-6) can be obtained using the above formulae (1) and (42).

$$\begin{matrix}\overline{{\tilde{u}}_{l θ} {\tilde{ω}}_{J θ}} + \overline{{\tilde{ω}}_{J θ} {\tilde{u}}_{l θ}} = 0 ∀ i , j i , j ∈ ( e 1 , e 2 , e 3 ) & ( 43 \text{-} 1 ) \\ \overline{{\tilde{u}}_{l θ} {\tilde{u}}_{J θ}} = 0 ∀ i \neq j i , j ∈ ( e 1 , e 2 , e 3 ) & ( 43 \text{-} 2 ) \\ \overline{{\tilde{ω}}_{l θ} {\tilde{ω}}_{J θ}} = 0 ∀ i \neq j i , j ∈ ( e 1 , e 2 , e 3 ) & ( 43 \text{-} 3 ) \\ \overline{‖ {\tilde{u}}_{e 1 θ} ‖} = \overline{‖ {\tilde{u}}_{e 2 θ} ‖} = \overline{‖ {\tilde{u}}_{e 3 θ} ‖} = \frac{\overline{‖ {\tilde{u}}_{θ} ‖}}{3} & ( 43 \text{-} 4 ) \\ \overline{‖ {\tilde{ω}}_{e 1 θ} ‖} = \overline{‖ {\tilde{ω}}_{e 2 θ} ‖} = \overline{‖ {\tilde{ω}}_{e 3 θ} ‖} = \frac{\overline{‖ {\tilde{ω}}_{θ} ‖}}{3} & ( 43 \text{-} 5 ) \\ \overline{‖ {\tilde{ω}}_{θ} ‖} \text{\textasciitilde} \frac{\partial {\tilde{u}}_{θ}}{\partial e 1} \frac{\partial {\tilde{u}}_{θ}^{*}}{\partial e 1} \text{\textasciitilde} \frac{\partial {\tilde{u}}_{θ}}{\overline{U} \partial t} \frac{\partial {\tilde{u}}_{θ}^{*}}{\overline{U} \partial t} \text{\textasciitilde} {( k \frac{{θ}_{m}}{\overline{U}} )}^{2} \overline{‖ {\tilde{u}}_{θ} ‖} & ( 43 \text{-} 6 )\end{matrix}$$

Here, k is a constant defining a relationship between the fluid velocity u_{θ} and the vorticity w_{θ}.

A following relational expression is satisfied between a spatial derivative and a time derivative.

$$\frac{\partial }{\partial e {1}_{i}} \text{\textasciitilde} \frac{\partial }{\overline{U} \partial t}$$

Therefore, when calculating a degree of contribution to the surface fluctuation in the convective pressure, an autocorrelation function of the disturbed vorticity ω˜ can be approximated as shown in a following formula (43-7).

$$\overline{‖ \tilde{ω} ‖} \text{\textasciitilde} \frac{\partial \tilde{u}}{\partial e 1} \frac{\partial {\tilde{u}}^{*}}{\partial e 1} \text{\textasciitilde} \frac{\partial \tilde{u}}{\overline{U} \partial t} \frac{\partial {\tilde{u}}^{*}}{\overline{U} \partial t} \text{\textasciitilde} {( k \frac{{θ}_{m}}{\overline{U}} )}^{2} \overline{‖ \tilde{u} ‖} \qquad ( 43 \text{-} 7 )$$

On the other hand, a following relational expression is satisfied between a spatial derivative and a time derivative of the acoustic pressure transmitted at the acoustic velocity.

$$\frac{\partial }{\partial e {1}_{i}} \text{\textasciitilde} \frac{\partial }{c \partial t}$$

Therefore, when calculating a degree of contribution to the surface acoustic pressure fluctuation, an autocorrelation function of the disturbed vorticity ω˜ can be approximated as shown in a following formula (43-8).

$$\overline{‖ \tilde{ω} ‖} \text{\textasciitilde} \frac{\partial \tilde{u}}{\partial e 1} \frac{\partial {\tilde{u}}^{*}}{\partial e 1} \text{\textasciitilde} \frac{\partial \tilde{u}}{c \partial t} \frac{\partial {\tilde{u}}^{*}}{c \partial t} \text{\textasciitilde} {( k \frac{{θ}_{m}}{c} )}^{2} \overline{‖ \tilde{u} ‖} \qquad ( 43 \text{-} 8 )$$

When rewriting the right side of the above formula (41) using the above formulae (43-1) to (43-8), the left side of the above formula (38) can be eventually expressed as shown in a following formula (44).

$${\int }_{θ l}^{θ h} ‖ 2 {( ω u )}_{θ} ( {z}_{2} ) \cdot ∇ {G}_{θ} ( x , {z}_{2} ) ‖ d θ = \frac{{k}_{0}^{2}}{12 {π}^{2} {r}^{4}} \overline{‖ {\tilde{u}}_{θ} ‖} {( k \frac{{θ}_{m}}{c} )}^{2} \{ {( {\overline{U}}_{e 2} \times r 1 - {\overline{U}}_{e 1} \times r 2 )}^{2} + {( {\overline{U}}_{e 1} \times r 3 - {\overline{U}}_{e 3} \times r 1 )}^{2} + {( {\overline{U}}_{e 3} \times r 2 - {\overline{U}}_{e 2} \times r 3 )}^{2} \} + \frac{{k}_{0}^{2}}{12 {π}^{2} {r}^{4}} \overline{‖ {\tilde{u}}_{θ} ‖} \{ {( {\overline{Ω}}_{e 2} \times r 1 - {\overline{Ω}}_{e 1} \times r 2 )}^{2} + {( {\overline{Ω}}_{e 1} \times r 3 - {\overline{Ω}}_{e 3} \times r 1 )}^{2} + {( {\overline{Ω}}_{e 3} \times r 2 - {\overline{Ω}}_{e 2} \times r 3 )}^{2} \} = \frac{{k}_{0}^{2}}{12 {π}^{2} {r}^{4}} \overline{‖ {\tilde{u}}_{θ} ‖} {( k \frac{{θ}_{m}}{c} )}^{2} {\vert \overline{U} \vec{r} \vert}^{2} + \frac{{k}_{0}^{2}}{12 {π}^{2} {r}^{4}} \overline{‖ {\tilde{u}}_{θ} ‖} {\vert \overline{Ω} \vec{r} \vert}^{2} \\ ( {\vert \vec{A} \vert}^{2} = {A}_{x}^{2} + {A}_{y}^{2} + {A}_{z}^{2} ) \qquad ( 44 )$$

The right side of the above formula (44) corresponds to a part of a “part to be integrated over the angular frequency band-of-interest” of the right side of the above formula (37), the part contributing to the surface acoustic pressure fluctuation. Therefore, when substituting the corresponding part of the formula (37) with the right side of the formula (44), a following formula (45) can be obtained.

$${\int }_{θ l}^{θ h} {\int }_{V} ‖ 2 {( ω u )}_{θ} ( {z}_{2} ) \cdot ∇ {G}_{θ} ( x , {z}_{2} ) ‖ {d}^{3} {z}_{2} d θ = {\int }_{V} \frac{{k}_{0}^{2} \overline{‖ {\tilde{u}}_{θ} ‖}}{12 {π}^{2} {r}^{4}} \{ {( k \frac{{θ}_{m}}{c} )}^{2} \times {\vert \overline{U} \vec{r} \vert}^{2} + {\vert \overline{Ω} \vec{r} \vert}^{2} \} {V}_{{z}_{2} , cr} {d}^{3} {z}_{2} \qquad ( 45 )$$

When multiplying a term to be integrated of the right side in the above formula (45) with a “square ρ² of the density of the flow field” and rewriting the evaluation point z2 with a general notation z, the calculation formula of APDS defined as shown in a following formula (46). In the present specification, the formula (46) derived in this way is defined as an index showing a degree of contribution of the “flow field at the evaluation point z within the flow domain 38” to the “surface acoustic pressure fluctuation pa_{θ}(x) at the observation point x of the rigid body 36”. It should be noted that a reason why ρ² is multiplied is because p*=p/ρ was used in a process of deriving the APDS calculation formula.

$$APDS ( x , z ) = \frac{{ρ}^{2} {k}_{0}^{2} \overline{‖ {\tilde{u}}_{θ} ‖}}{12 {π}^{2} {r}^{4}} \{ {( k \frac{{θ}_{m}}{c} )}^{2} \times {\vert \overline{U} \vec{r} \vert}^{2} + {\vert \overline{Ω} \vec{r} \vert}^{2} \} {V}_{z , cr} \qquad ( 46 )$$

Between the surface acoustic pressure fluctuation pa_{θ}(x) and APDS (x, z) at the observation point x, an approximate expression shown in a following formula (47) is satisfied (refer to the formulae (35), (45), and (46)).

$${\int }_{θ l}^{θ h} ‖ {pa}_{θ} ( x ) ‖ d θ = {\int }_{θ l}^{θ h} pa ( x ) {pa}_{θ} {}^{*} ( x ) d θ = {ρ}^{2} {\int }_{θ l}^{θ h} {pa}_{* θ} ( x ) {pa}_{θ} {}^{*} ( x ) d θ = {ρ}^{2} {\int }_{θ l}^{θ h} ‖ {pa}_{* θ} ( x ) ‖ d θ \text{\textasciitilde} {ρ}^{2} {\int }_{V} {\int }_{θ l}^{θ h} ‖ 2 {( ω u )}_{θ} ( z ) \cdot ∇ {G}_{θ} ( x , z ) ‖ d θ \times {V}_{z , cr} {d}^{3} z = {\int }_{V} \frac{{ρ}^{2} {k}_{0}^{2} \overline{‖ {\tilde{u}}_{θ} ‖}}{12 {π}^{2} {r}^{4}} \{ {( k \frac{{θ}_{m}}{c} )}^{2} \times {\vert \overline{U} \vec{r} \vert}^{2} + {\vert \overline{Ω} \vec{r} \vert}^{2} \} {V}_{z , cr} {d}^{3} z = {\int }_{V} APDS ( x , z ) {d}^{3} z \qquad ( 47 )$$

That is, an integrated value of a “norm of the surface acoustic pressure fluctuation pa_{θ}(x) at the observation point x” in the angular frequency band-of-interest (in other words, an autocorrelation function of the surface acoustic pressure fluctuation pa_{θ}(x) at the observation point x) can be approximated as a “value obtained by a space integration of APDS at the observation point x over the flow domain”. Hence, APDS serves as the index showing a degree of contribution of the flow field at the evaluation point z to the surface acoustic pressure fluctuation pa_{θ}(x) at the observation point x with a high accuracy. This is the description on the derivation of the APDS calculation formula.

### <Method for Analyzing Wind Noise>

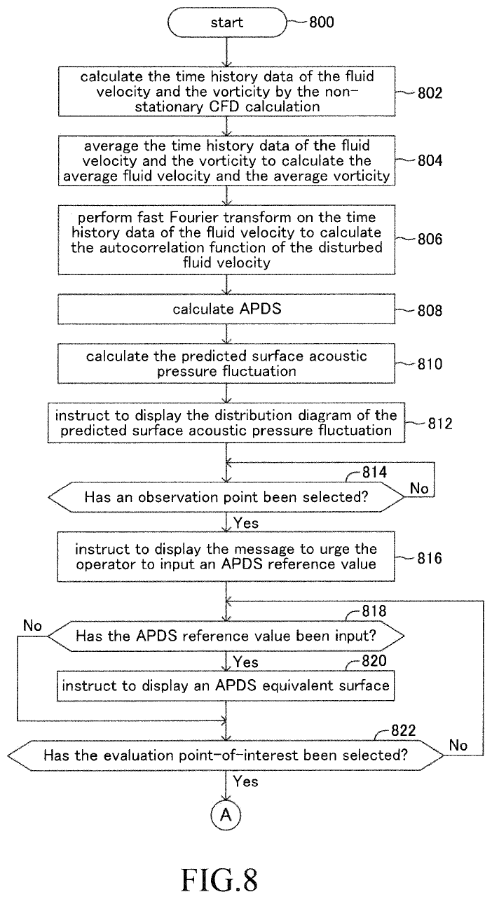

Next, specific description on a method for analyzing wind noise of the traveling vehicle model 20 will be made. The CPU of the operation part 14 of the calculation apparatus 10 is configured to perform a routine shown by a flowchart in FIG. 8. The CPU initiates processing from a step 800 in FIG. 8 and performs processing of a step 802 to a step 812 stated below.

Step 802: The CPU initiates the non-stationary CFD simulation to make the vehicle model 20 travel and calculates, within the analysis scope (flow domain 21), the time history data u (z, t) of the fluid velocity and the time history data ω (z, t) of the vorticity over a predetermined period of time, respectively. These data is calculated for every node z.

Step 804: The CPU averages the time history data u (z, t) of the fluid velocity and the time history data ω (z, t) of the vorticity calculated at the step 802, respectively to calculate the average fluid velocity U-(z) and the average vorticity Ω-(z) for each node z.

Step 806: The CPU performs fast Fourier transform on the time history data u (z, t) of the fluid velocity calculated at the step 802 to calculate the autocorrelation function of the disturbed fluid velocity u˜_{θ}(z) in the angular frequency band-of-interest. This autocorrelation function is calculated for every node z. The processing from the step 802 to the step 806 corresponds to the non-stationary CFD calculation process.

Step 808: The CPU calculates, using the APDS calculation formula (refer to the formula (46)) stored in the RAM of the operation part 14, APDS in the angular frequency band-of-interest for a node x on the surface-to-be-analyzed at each node z. The CPU performs this processing for the whole nodes x on the surface-to-be-analyzed. That is, a total of mn APDSs are calculated (m: the number of the nodes x, n: the number of the nodes z). The autocorrelation functions etc. of the average fluid velocity U-(z) and the average vorticity Ω-(z) calculated at the step 804 and the disturbed fluid velocity u˜_{θ}(z) calculated at the step 806 are substituted for this calculation formula.

Step 810: The CPU extracts n APDSs for an arbitrary node x out of mn APDSs calculated at the step 808 to perform a space integration of the extracted APDSs over the flow domain 21 and thereby calculates the approximate value of the autocorrelation function of the surface acoustic pressure fluctuation pa_{θ} (x) in the angular frequency band-of-interest at this node x. Thereafter, the CPU calculates (predicts), based on this approximated value, the predicted surface acoustic pressure fluctuation pa_{pθ}(x) at this node x. The CPU performs this processing for the whole nodes x on the surface-to-be-analyzed. That is, a total of m predicted surface acoustic pressure fluctuations pa_{pθ}(x)s are calculated.

Step 812: The CPU creates, based on the predicted surface acoustic pressure fluctuation pa_{pθ}(x) in the angular frequency band-of-interest calculated at the step 810, the “data indicating the distribution diagram of the predicted surface acoustic pressure fluctuation pa_{pθ}(x) at the center angular frequency θₘ of the angular frequency band-of-interest” and transmit to the output part 16 the display instruction of this data. Thereby, the distribution diagram of the predicted surface acoustic pressure fluctuation pa_{pθ}(x) is displayed on the display screen 18 (refer to FIG. 3A). Thereafter, the CPU proceeds to a step 814.

In the step 814, the CPU determines whether or not an observation point x has been selected by the operator. This observation point x is selected by the operator based on the distribution diagram of the predicted surface acoustic pressure fluctuation pa_{pθ}(x) (refer to the step 812). When having determined that the observation point x was selected, the CPU makes an “Yes” determination at the step 814 to perform processing of a step 816 mentioned later. In contrast, when having determined that the observation point x was not selected, the CPU makes a “No” determination at the step 814 to make the determination at the step 814 again. The CPU repeats this processing every time a predetermined calculation interval elapses until it is determined that the observation point x has been selected.

Step 816: The CPU transmits to the output part 16 the display instruction of the message to urge the operator to input a reference value of APDS. Thereby, the message is displayed on the display screen 18, enabling the operator to input the reference value of APDS. Thereafter, the CPU proceeds to a step 818.

In the step 818, the CPU determines whether or not the reference value of APDS has been input by the operator. When having determined that the reference value was input, the CPU makes an “Yes” determination at the step 818 to perform processing of a following step 820.

Step 820: The CPU extracts n APDSs for the observation point x selected at the step 814 out of mn APDSs calculated at the step 808. The CPU thereafter identifies APDS having the reference value input at the step 818 out of the extracted APDSs and creates the data indicating an equivalent surface of this APDS to transmit the display instruction of this data to the output part 16. Thereby, the equivalent surface of the APDS with the reference value input by the operator is displayed on the display screen 18 (refer to FIG. 4A to FIG. 4C). Thereafter, the CPU proceeds to a step 822.

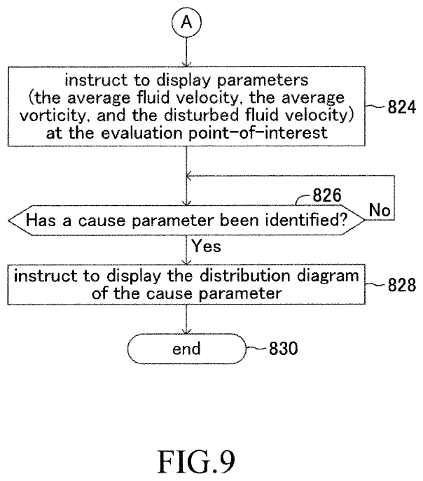

In the step 822, the CPU determines whether or not an evaluation point-of-interest z has been selected by the operator. This evaluation point-of-interest z is selected by the operator based on the equivalent surface of the APDS (refer to the step 820). When having determined that the evaluation point-of-interest z was selected, the CPU makes an “Yes” determination at the step 822 to perform processing of a step 824 (FIG. 9) mentioned later.

In contrast, when having determined that the evaluation point-of-interest z was not selected (specifically, when the operator is not able to select any evaluation point-of-interest z from the current APDS equivalent surface, or when the operator is selecting the evaluation point-of-interest z), the CPU makes a “No” determination at the step 822 to make the determination at the step 818 again.

When having determined at the step 818 that the reference value was input (that is, when the reference value of APDS was input again by the operator), the CPU makes an “Yes” determination at the step 818 to perform the processing of the step 820 and again determines at the step 822 whether or not the evaluation point-of-interest z has been selected. On the other hand, when having determined at the step 818 that the reference value was not input, the CPU makes a “No” determination at the step 818 to proceed to the step 822 and again determines at the step 822 whether or not the evaluation point-of-interest z has been selected. The CPU repeats the processing from the step 818 to the step 822 until it is determined that the evaluation point-of-interest z has been selected.

In contrast, when having determined that the reference value was not input in a case when the CPU directly proceeds to the step 818 from the step 816 (that is, when an initial reference value was not input), the CPU makes a “No” determination at the step 818 to proceed to the step 822. As mentioned above, since the evaluation point-of-interest z is selected based on the APDS equivalent surface (that is, selected via the step 820), if the initial reference value was not input (that is, if the step 820 was not passed), the CPU makes a “No” determination at the step 822.

Step 824 (FIG. 9): The CPU extracts APDS (x, z) out of APDSs (x, z) having the reference value input at the step 818, the extracted APDS being a value at the evaluation point-of-interest z selected at the step 822. The CPU transmits to the output part 16 the display instruction of the numerical data of the parameters constituting the extracted APDS (x, z). Specifically, these parameters are the average fluid velocity U-(z), the disturbed fluid velocity u˜_{θ}(z), and the average vorticity Ω-(z) at the evaluation point-of-interest z (refer to the steps 804 and 806). Thereby, the numerical data of the parameters constituting the APDS (x, z) is displayed on the display screen 18. Thereafter, the CPU proceeds to a step 826.

In the step 826, the CPU determines whether or not a cause parameter has been identified. This cause parameter is identified by the operator based on the numerical data (refer to the step 824) of the parameters constituting the APDS (x, z). When having determined that the cause parameter was identified, the CPU makes an “Yes” determination at the step 826 to perform processing of a step 828 mentioned later. In contrast, when having determined that the cause parameter was not identified, the CPU makes a “No” determination at the step 826 to make the determination at the step 826 again. The CPU repeats this processing every time the predetermined calculation interval elapses until it is determined that the cause parameter has been identified.

Step 828: The CPU creates the data indicating the distribution diagram of the cause parameter on a predetermined plane (typically, a plane parallel to the e1e2 plane, that is, the cross section-passing-the-evaluation-point-of-interest) passing the evaluation point-of-interest z selected at the step 822. The CPU transmits to the output part 16 the display instruction of this data. Thereby, the distribution diagram of the cause parameter is displayed on the display screen 18 (refer to FIG. 5B). The CPU thereafter proceeds to a step 830 to terminate the present routine.

### <Improved Effect of the Surface Acoustic Pressure Fluctuation (Wind Noise) by the Present Embodiment Apparatus>

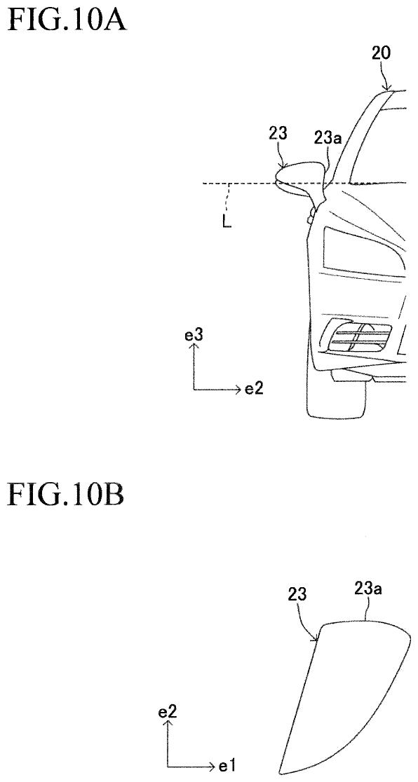

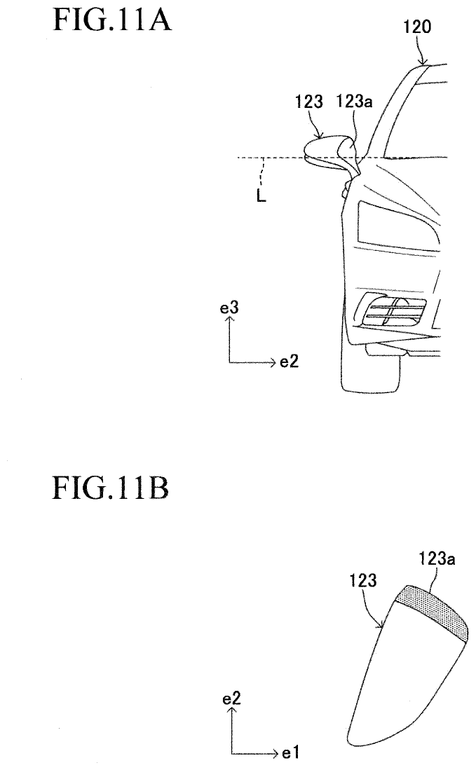

Next, a description on an improved effect of the surface acoustic pressure fluctuation pa_{θ}(x) in the frequency band-of-interest (2 kHz in this example) in a case when a shape of the vehicle model 20 in the analysis scope is changed using the present embodiment apparatus will be made in detail, referring to FIG. 10A to FIG. 13. In the examples in FIG. 5A and FIG. 5B, a shape of the right-sided side mirror 23 is examined, the shape being capable of increasing the air resistance in the region 34. FIG. 10A shows a part of a front view of the vehicle model 20 at a−e2 direction side, and FIG. 10B shows an outline of a plan view of the right-sided side mirror 23. As shown in FIG. 10A and FIG. 10B, a face 23a of the right-sided side mirror 23 at the vehicle body side (an e2 direction side) is substantially parallel to a forward direction (an e1 direction) of the vehicle model 20. The inventor of the present application considered that this reduces the air resistance in the vicinity of the face 23a and examined a shape capable of increasing the air resistance in the vicinity of the face 23a. FIG. 11A shows a part of a front view of a vehicle model 120 at the −e2 direction side, the shape thereof being changed based on the examination, and FIG. 11B shows an outline of a plan view of a right-sided side mirror 123 of the vehicle model 120. As shown in FIG. 11A and FIG. 11B, a face 123a of the right-sided side mirror 123 at the vehicle body side (the e2 direction side) has a direction crossing with the forward direction (the e1 direction) of the vehicle model 120, and thereby the air resistance in the vicinity of the face 123a is increased.

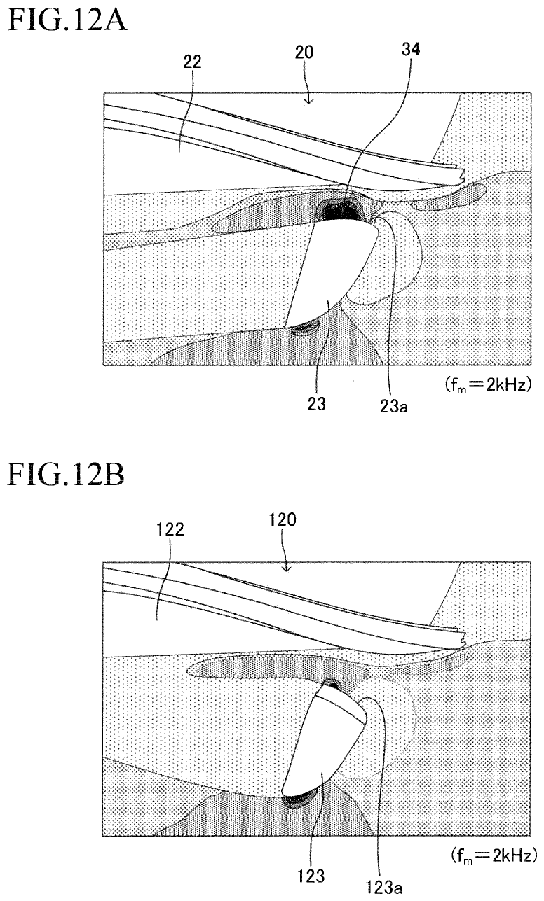

FIG. 12A shows a distribution diagram of the average fluid velocity U-(z) around the right-sided side mirror 23 on the cross section-passing-the-evaluation-point-of-interest (refer to a dashed line L in FIG. 10A) before the shape is changed (the vehicle model 20). FIG. 12B shows a distribution diagram of the average fluid velocity U-(z) around the right-sided side mirror 123 on the cross section-passing-the-evaluation-point-of-interest (refer to a dashed line L in FIG. 11A) after the shape is changed (the vehicle model 120). As shown in FIG. 12A and FIG. 12B, the average fluid velocity U-(z) in a region in the vicinity of the vehicle body side of the right-sided side mirror 123 is significantly reduced compared with the region 34 by changing the shape of the right-sided side mirror.

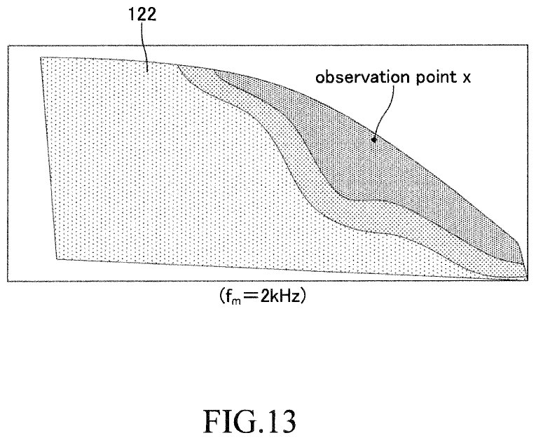

FIG. 13 shows a distribution diagram of the predicted surface acoustic pressure fluctuation pa_{pθ}(x) on the surface-to-be-analyzed (a right-sided front side glass 122) after the shape is changed. Comparing FIG. 13 with FIG. 3A (the distribution diagram of the predicted surface acoustic pressure fluctuation pa_{pθ}(x) on the surface-to-be-analyzed before the shape is changed), the predicted surface acoustic pressure fluctuation pa_{pθ}(x) at the observation point x is significantly reduced in FIG. 13. From the above, according to the present embodiment apparatus, it is shown that the surface acoustic pressure fluctuation (wind noise) of the vehicle model in the high-frequency region can be reduced in an efficient and reliable way by identifying, using APDS, a position of the flow field having a large contribution to the surface acoustic pressure fluctuation of the vehicle model.

### <Reliability and Versatility of APDS as Index>

As stated above, a “value obtained by a space integration of APDS in the frequency band-of-interest for a node x over the flow domain” is an approximate value of an “autocorrelation function of the surface acoustic pressure fluctuation pa_{θ}(x) in the frequency band-of-interest at the node x” (refer to the formula (47)). The present embodiment apparatus calculates the predicted surface acoustic pressure fluctuation pa_{pθ}(x) at a node x based on APDS by making use of the relationship mentioned above. Hereinafter, an approximation accuracy of the predicted surface acoustic pressure fluctuation pa_{pθ} will be verified (inspected) and reliability of APDS as an index will be considered. Specifically, this verification (inspection) is conducted by comparing the predicted surface acoustic pressure fluctuation pa_{pθ} with the surface acoustic pressure fluctuation pa_{θ} calculated by a software for the non-stationary CFD calculation. In the present embodiment, a software named PowerFLOW is used, but a type of a software is not limited thereto. It should be noted that a reason why the present embodiment apparatus calculates (predicts) the surface acoustic pressure fluctuation not by the non-stationary CFD calculation but by APDS (refer to the step 810) is because the non-stationary CFD calculation requires a significant amount of time. For example, in a case when calculating the surface acoustic pressure fluctuation at the right-sided front side glass 22 of the vehicle model 20 for every node x, the non-stationary CFD calculation requires three months whereas the calculation based on APDS only requires two days.

Further, hereinafter, versatility of APDS as an index is considered as well by verifying the above approximation accuracy for not only the vehicle model but also a fore step model having a different shape from the vehicle model.

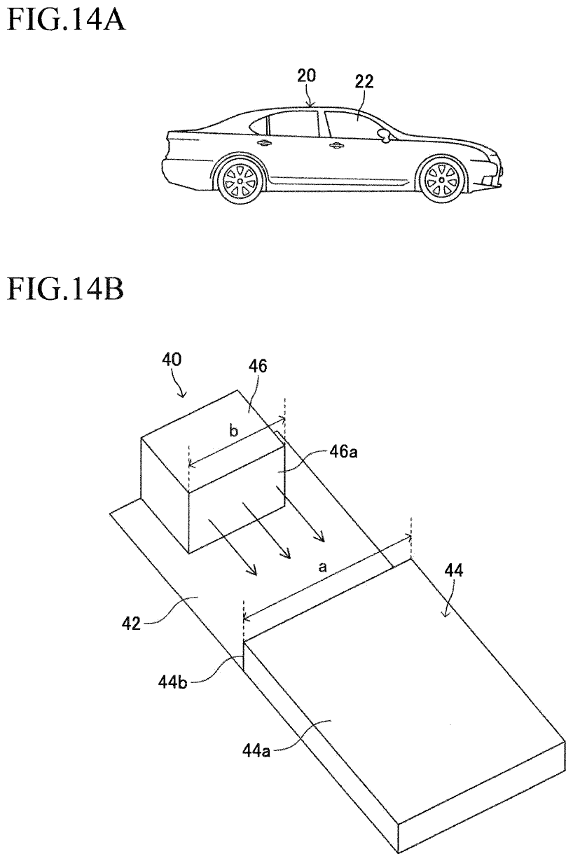

FIG. 14A is the vehicle model 20 used in the above description. FIG. 14B is a schematic diagram of a fore step model 40. The fore step model 40 includes a reference face 42, a step 44 with a parallelepiped shape disposed on top of the reference face 42, and a nozzle 46 disposed on the reference face 42 at a separated position from the step 44. An upper face 44a of the step 44 is parallel to the reference face 42. A level difference is formed between a lateral face 44b (a face at a nozzle 46 side) of the step 44 and the reference face 42. The nozzle 46 includes an air-blowing port 46a facing in parallel with the lateral face 44b of the step 44. The air-blowing port 46a blows wind toward the step 44. A length a of the step 44 in a width direction (a direction perpendicular to a direction of blowing wind) is longer than a length b of the nozzle 46 in the width direction. A height of the step 44 is lower than a height of the nozzle 46. A center of the nozzle 46 in the width direction and a center of the step 44 in the width direction match with each other in the width direction. In this verification, the right-sided front side glass 22 of the vehicle model 20 and the upper face 44a of the step 44 of the fore step model 40 are subject to be analyzed.

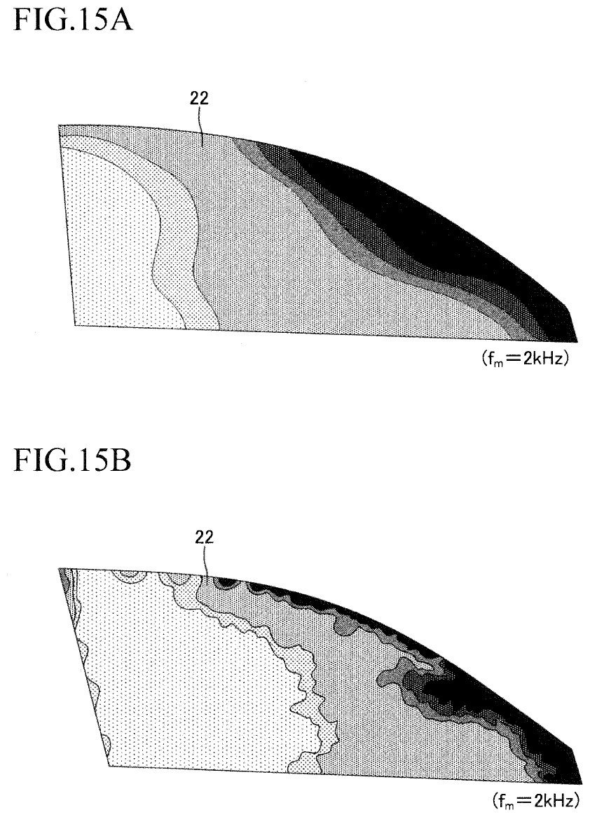

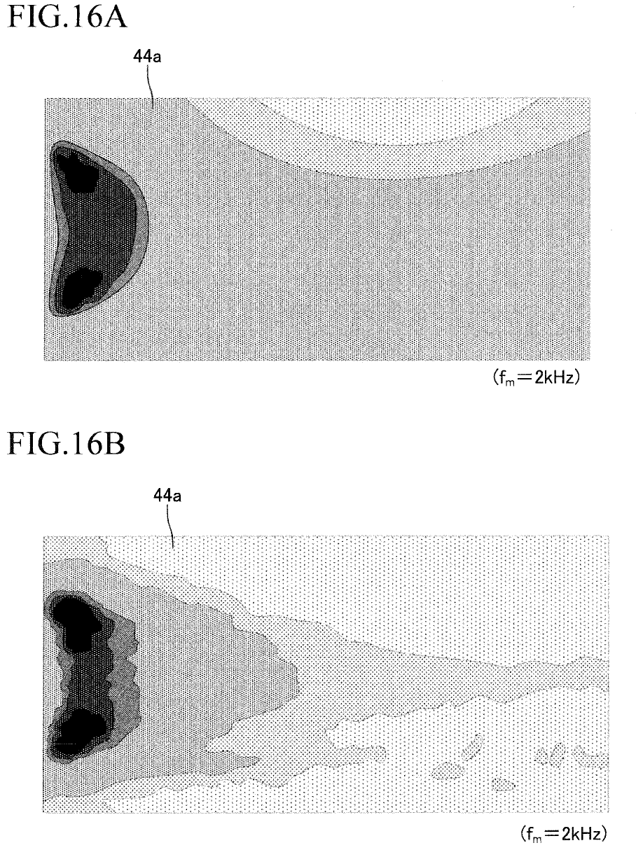

FIG. 15A and FIG. 15B are distribution diagrams of the predicted surface acoustic pressure fluctuation pa_{pθ} and the surface acoustic pressure fluctuation pa_{θ} at the right-sided front side glass 22 of the vehicle model 20, respectively. The frequency band-of-interest is set to 2 kHz. FIG. 16A and FIG. 16B are distribution diagrams of the predicted surface acoustic pressure fluctuation pa_{pθ} and the surface acoustic pressure fluctuation pa_{θ} at the upper face 44a of the step 44 of the fore step model 40, respectively. The frequency band-of-interest is set to 2 kHz. As the predicted surface acoustic pressure fluctuation pa_{pθ} and the surface acoustic pressure fluctuation pa_{θ} become larger, they are indicated in a thicker color. Comparing FIG. 15A with FIG. 15B, a magnitude and a position of the predicted surface acoustic pressure fluctuation pa_{pθ} well matches with a magnitude and a position of the surface acoustic pressure fluctuation pa_{θ} especially in a region with a large value. Similarly, comparing FIG. 16A with FIG. 16B, a magnitude and a position of the predicted surface acoustic pressure fluctuation pa_{pθ} well matches with a magnitude and a position of the surface acoustic pressure fluctuation pa_{θ} especially in a region with a large value. From the above, it is shown that the predicted surface acoustic pressure fluctuation pa_{pθ} calculated based on APDS has a high approximation accuracy with respect to the surface acoustic pressure fluctuation pa_{θ} calculated by the CFD calculation of the software. This indicates that APDS has a high reliability as the index.

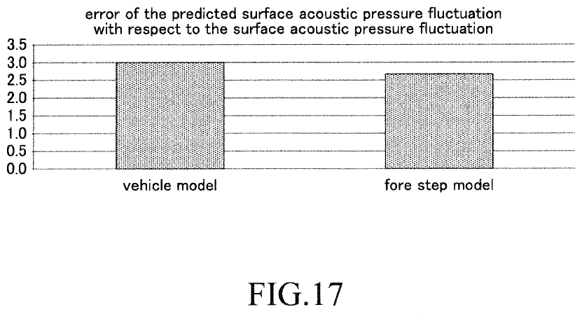

FIG. 17 is a graph showing an “error of the predicted surface acoustic pressure fluctuation pa_{pθ} with respect to the surface acoustic pressure fluctuation pa_{θ}” for each of the vehicle model 20 and the fore step model 40. The error for the vehicle model 20 is a value obtained by converting an average of a difference into an acoustic pressure fluctuation level (dB), the difference being a “difference of the predicted surface acoustic pressure fluctuation pa_{pθ} with respect to the surface acoustic pressure fluctuation pa_{θ}” at each of corresponding nodes x of two distribution diagrams shown in FIG. 15A and FIG. 15B. The error for the fore step model 40 is a value obtained by converting an average of a difference into an acoustic pressure fluctuation level (dB), the difference being a “difference of the predicted surface acoustic pressure fluctuation pa_{pθ} with respect to the surface acoustic pressure fluctuation pa_{θ}” at each of corresponding nodes x of two distribution diagrams shown in FIG. 16A and FIG. 16B. Comparing the error for the vehicle model 20 with the error for the fore step model 40, both errors have substantially equal values of approximately 3 dB. From the above, it is shown that the error of the predicted surface acoustic pressure fluctuation pa_{pθ} with respect to the surface acoustic pressure fluctuation pa_{θ} is substantially constant regardless of the shapes of models to be analyzed. This indicates that APDS has a high versatility as the index.

Effects of the present embodiment apparatus will be described. The present embodiment apparatus calculates APDS in the angular frequency band-of-interest based on the physical quantities (the average fluid velocity U-, the average vorticity Ω-, and the disturbed fluid velocity u˜_{θ}) calculated by the non-stationary CFD simulation to make the vehicle model travel. This APDS (x, z) is an index showing a degree of contribution of the “flow field at an evaluation point z within the analysis scope (the flow domain 21)” to the “surface acoustic pressure fluctuation pa_{θ}(x) in the angular frequency band-of-interest at the observation point x on the surface-to-be-analyzed (the right-sided front side glass 22) of the vehicle model 20”. Therefore, using APDS as the index enables to calculate the degree of contribution of the flow field to the surface acoustic pressure fluctuation pa_{θ}(x) in the angular frequency band-of-interest for every evaluation point z. Hence, it becomes possible to properly identify what position of the flow field within the flow domain 21 has a large contribution to the surface acoustic pressure fluctuation pa_{θ}(x) in the high-frequency region on the glass-made part (the right-sided front side glass 22 in the present embodiment) of the vehicle model 20 at the observation point x.

In addition, in the present embodiment apparatus, a value obtained by a space integration of APDS for the observation point x over the flow domain 21 is an approximate value of the autocorrelation function of the surface acoustic pressure fluctuation pa_{θ}(x) at this observation point x. Therefore, a behavior of APDS accurately matches with a behavior of the surface acoustic pressure fluctuation pa_{θ}(x). That is, APDS has a high reliability as the index showing the degree of contribution of the flow field to the surface acoustic pressure fluctuation pa_{θ}(x) (refer to FIG. 14A to FIG. 17). Therefore, it becomes possible to identify a position of the flow field with high accuracy, the position having a large contribution to the surface acoustic pressure fluctuation pa_{θ}(x) in the high-frequency region at the glass-made part of the vehicle model.

Specifically, a conventional apparatus could not quantitatively evaluate the relationship mentioned above, which sometimes caused a problem that interpretation of the flow field varies depending on engineers. Besides, since the analysis is performed based on a distribution of a physical quantity on a cross section of the flow field, information of the flow field in a three-dimensional space is likely to be lost and a cause making the surface acoustic pressure fluctuation large is likely to be missed. In contrast, according to the present embodiment apparatus, a quantitative relationship between the surface acoustic pressure fluctuation pa_{θ}(x) and the flow field can be evaluated using APDS, and thus a possibility that the interpretation of the flow field varies depending on engineers can be significantly reduced, leading to improvement in an analysis accuracy of wind noise. In addition, in the present embodiment, a position of the flow field with a large degree of contribution to the surface acoustic pressure fluctuation is identified first and thereafter a distribution of a physical quantity on a cross section passing this identified position is evaluated. Therefore, a possibility of the information of the flow field being lost can be significantly reduced and as a result, it becomes possible to surely discover a cause making the surface acoustic pressure fluctuation large.

Further, in the present embodiment apparatus, the equivalent surface of APDS is displayed on the display screen 18, which enables the operator to visually recognize the equivalent surface having a desired APDS value by the operator properly setting an input value. As a result, the operator can select the evaluation point z corresponding to the desired APDS value in an efficient way and identify the position of the flow field, the position having a large contribution to the surface acoustic pressure fluctuation pa_{θ}(x) in the high-frequency region at the glass-made part of the vehicle model 20 in an efficient way.

Further, in the present embodiment apparatus, the observation point x is selected based on a magnitude of the predicted surface acoustic pressure fluctuation pa_{pθ} calculated (predicted) based on APDS. The predicted surface acoustic pressure fluctuation pa_{pθ} has a strong correlation with wind noise. Therefore, according to this configuration, it becomes possible to analyze wind noise in a more proper way.

### Modification Example 1

Next, a wind noise analyzing apparatus according to a modification example 1 (hereinafter, also referred to as a “first modification apparatus”) will be described. The first modification apparatus is different from the above embodiment apparatus in that identification of the cause parameter is performed not by the operator but by the apparatus. Specifically, the first modification apparatus performs a following processing in place of the processing of the steps 824 and 826 in FIG. 9. That is, an operation part of a calculation apparatus of the first modification apparatus identifies a parameter with a relatively large contribution to the APDS value as a cause parameter, the identified parameter being identified out of three parameters (the average fluid velocity U-, the average vorticity Ω-, and the disturbed fluid velocity u˜_{θ}) constituting APDS at the evaluation point-of-interest z selected at the step 822. Specifically, the operation part identifies the cause parameter by comparing numerical values of three parameters at the evaluation point-of-interest z with numerical values of three parameters at an “evaluation point z corresponding to an APDS value smaller than the APDS value at the evaluation point-of-interest z”. According to this configuration, it becomes unnecessary for the operator to identify a cause parameter. Therefore, a parameter causing a large APDS value can be easily grasped, enabling to examine and change a shape of the vehicle model in a more efficient way.

### Modification Example 2

Subsequently, a wind noise analyzing apparatus according to a modification example 2 (hereinafter, also referred to as a “second modification apparatus”) will be described. The second modification apparatus is different from the above embodiment apparatus in that selection (extraction) of the evaluation point-of-interest z is performed not by the operator but by the apparatus. Specifically, the second modification apparatus performs a following processing in place of the processing from the step 816 to the step 822 in FIG. 8. That is, when having made an “Yes” determination at the step 814, an operation part of a calculation apparatus of the second modification apparatus creates an equivalent surface data of APDS having an arbitrary value and thereafter continues to create data of equivalent surfaces, changing an APDS value until equivalent surfaces shown by the data are reduced to a few surfaces (Strictly, the operation part continues to increase an APDS value until a surface area of each equivalent surface becomes as small as possible even after the equivalent surfaces are reduced to a few surfaces.). Thereafter, the operation part extracts an arbitrary point as the evaluation point-of-interest z, the arbitrary point being on an equivalent surface, a distance thereof to the observation point x being the longest. According to this configuration, it becomes unnecessary for the operator to select the evaluation point-of-interest z, and thus it becomes possible to identify the position of the flow field, the position having a large contribution to the surface acoustic pressure fluctuation in the high-frequency region at the glass-made part of the vehicle model in a more efficient way. It should be noted that the second modification example extracts an evaluation point z corresponding to the maximum (substantially maximum) APDS value as the evaluation point-of-interest z. However, a configuration is not limited thereto. That is, a configuration where an evaluation point-of-interest z satisfying a predetermined condition is extracted may be adopted.

The wind noise analyzing apparatus and the method for analyzing wind noise according to the present embodiment and the modification examples have been described. However, the present invention is not limited to the aforementioned embodiment and modification examples and may adopt various modifications within a scope of the present invention.

For example, in the above embodiment and modification examples, the vehicle model is used as a structure model subject to be analyzed. However, a configuration is not limited thereto. For instance, structure models such as an aircraft, a watercraft, and the like may be used.

In addition, in the above embodiment and modification examples, an observation point with a relatively large surface acoustic pressure fluctuation is set to be a target point-to-be-analyzed. However, a configuration is not limited thereto. For instance, the analysis may be performed by setting a node x having an average value of surface acoustic pressure fluctuations in a predetermined area as an observation point.

Further, in the above embodiment and modification examples, the node z which can be selected as the evaluation point-of-interest z is positioned on the equivalent surface. However, a configuration is not limited thereto. For instance, a node z inside the equivalent surface may be selected as the evaluation point-of-interest z.

Further, in the above embodiment and modification examples, the observation point x is selected by the operator. However, a configuration is not limited thereto. For instance, the wind noise analyzing apparatus may select the observation point x based on the value of the surface acoustic pressure fluctuation.

Further, in the above embodiment and modification examples, the observation point x is selected based on the distribution diagram of the surface acoustic pressure fluctuation. However, a configuration is not limited thereto. For instance, the observation point x may be selected based on a physical quantity other than the surface acoustic pressure fluctuation or an arbitrary node x may be selected as the observation point x by the operator.

1. A wind noise analyzing apparatus to analyze wind noise generated on a surface of a glass-made part which is a part made of glass of a moving structure comprising;
non-stationary CFD calculation means for running a non-stationary CFD simulation to make a structure model move to calculate an average fluid velocity and an average vorticity in a predetermined period of time of a flow field within a predetermined region out of a flow field around said structure model for every spatial node which is a node within said predetermined region as well as to calculate a value based on an amplitude of a disturbed fluid velocity within said predetermined region for said every spatial node in an angular frequency band-of-interest which is an angular frequency band, wind noise is to be analyzed therein; and
acoustic pressure density source calculating means for calculating, based on said average fluid velocity, said average vorticity, and said amplitude of said disturbed fluid velocity, each of which being calculated by said non-stationary CFD calculation means, an acoustic pressure density source which is an index showing a degree of contribution of a flow field at a spatial node within said predetermined region to a surface acoustic pressure fluctuation which is an amplitude of a fluctuation in an acoustic pressure in an angular frequency band-of-interest at a target point-to-be-analyzed which is a point at which wind noise is to be analyzed, said wind noise being on a surface of a glass-made part of said structure model.

2. The wind noise analyzing apparatus according to claim 1, wherein,
a value obtained by a space integration of said acoustic pressure density source in an angular frequency band-of-interest for said target point-to-be-analyzed on said surface of said glass-made part of said structure model over said predetermined region is an approximate value of a value obtained by integrating a product of a function of said surface acoustic pressure fluctuation at said target point-to-be-analyzed and a complex conjugate function thereof over said angular frequency band-of-interest.

3. The wind noise analyzing apparatus according to claim 1 further comprising a cause parameter identifying means for identifying a cause parameter which is a parameter out of a plurality of parameters constituting said acoustic pressure density source, said parameter having a relatively large contribution to said acoustic pressure density source.

4. The wind noise analyzing apparatus according to claim 3, wherein
said plurality of parameters are said average fluid velocity, said average vorticity, and said disturbed fluid velocity.

5. The wind noise analyzing apparatus according to claim 1 further comprising image processing means for extracting spatial nodes out of a plurality of spatial nodes at each of which said acoustic pressure density source has been calculated, said extracted spatial nodes corresponding to an acoustic pressure density source having a value input from outside, performing an image processing of said extracted spatial nodes to create an equivalent surface, and visualizing said equivalent surface.

6. The wind noise analyzing apparatus according to claim 1 further comprising spatial node extracting means for extracting a spatial node corresponding to a maximum value among a plurality of acoustic pressure density sources calculated by said acoustic pressure density source calculating means.

7. The wind noise analyzing apparatus according to claim 1, wherein,
a calculation formula of said acoustic pressure density source is defined by a following formula;
$$APDS ( x , z ) = \frac{{ρ}^{2} {k}_{0}^{2} \overline{‖ {\tilde{u}}_{θ} ‖}}{12 {π}^{2} {r}^{4}} \{ {( k \frac{{θ}_{m}}{c} )}^{2} \times {\vert \overline{U} \vec{r} \vert}^{2} + {\vert \overline{Ω} \vec{r} \vert}^{2} \} {V}_{z , cr} \qquad$$
where APDS represents an acoustic pressure density source, x represents a target point-to-be-analyzed, z represents a spatial node, ρ represents a density of a flow field, k₀ represents an acoustic wave number, a norm of u˜_{θ} with a bar thereon represents a value obtained by integrating a product of a function of an amplitude of a disturbed fluid velocity and a complex conjugate function thereof over an angular frequency band-of-interest, r represents a distance between x and z, k represents a constant, θₘ represents a center angular frequency in a angular frequency band-of-interest, c represents an acoustic velocity of a flow field, U- represents an average fluid velocity, a vector r represents an expression of a vector z-a vector x, Ω- represents an average vorticity, and V_{z,cr} represents a correlation volume including z.

8. A wind noise analyzing method for analyzing wind noise generated on a surface of a glass-made part which is a part made of glass of a moving structure comprising;
non-stationary CFD calculation process for running a non-stationary CFD simulation to make a structure model move to calculate an average fluid velocity and an average vorticity in a predetermined period of time of a flow field within a predetermined region out of a flow field around said structure model for every spatial node which is a node within said predetermined region as well as to calculate a value based on an amplitude of a disturbed fluid velocity within said predetermined region for said every spatial node in an angular frequency band-of-interest which is an angular frequency band, wind noise is to be analyzed therein; and
acoustic pressure density source calculating process for calculating, based on said average fluid velocity, said average vorticity, and said amplitude of said disturbed fluid velocity, each of which being calculated by said non-stationary CFD calculation process, an acoustic pressure density source which is an index showing a degree of contribution of a flow field at a spatial node within said predetermined region to a surface acoustic pressure fluctuation which is an amplitude of a fluctuation in an acoustic pressure in an angular frequency band-of-interest at a target point-to-be-analyzed which is a point at which wind noise is to be analyzed, said wind noise being on a surface of a glass-made part of said structure model.
